(19) United States
(12) Patent Application Publication
(10) Pub. No.: US 2006/0216639 A1
(43) Pub. Date: Sep. 28, 2006

(54) Planographic printing plate precursor and method of producing the same

(75) Inventor: Hiroshi Tashiro, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/384,256

(22) Filed: Mar. 21, 2006

(30) Foreign Application Priority Data
Mar. 22, 2005 (JP) 2005-082771

(51) Int. Cl. G03C 1/00

(52) U.S. Cl. 430/270.1

(57) ABSTRACT

A planographic printing plate precursor of the present invention comprises: a support and a positive recording layer arranged on the support. the positive recording layer containing resin and an infrared absorber and being constituted of two or more sub-layers, wherein the solubility of the positive recording layer to an aqueous alkali solution is increased by exposure to infrared laser light, and for the positive recording sub-layer of the two or more positive recording sub-layers that is nearest to the support (the lower layer), the ratio of the dissolution speed to an aqueous alkali solution in the lateral direction to the dissolution speed in the depth direction is less than 1. Such a ratio of the dissolution speeds can be achieved by forming a dispersed phase in the lower layer and/or high-temperature drying when forming the lower layer. According to the invention, there is provided a positive planographic printing plate precursor for infrared laser for direct plate making, which is excellent in scratch resistance and in discrimination of formed images.

### CROSS-REFERENCE TO RELATED APPLICATION

This application claims priority under 35 USC 119 from Japanese Patent Application No. 2005-082771, the disclosure of which is incorporated by reference herein.

### BACKGROUND OF THE INVENTION

1. Field of the Invention

The present invention relates to a planographic printing plate precursor. More specifically, the invention relates to an infrared-laser-applicable planographic printing plate precursor for a so-called CTP (Computer To Plate), from which a printing plate can be directly formed based on digital signals from a computer or the like.

2. Description of the Related Art

The development of lasers for planographic printing in recent years has been remarkable. In particular, high-power, small-sized solid lasers and semiconductor lasers that emit near-infrared and infrared rays have become easily obtainable. These lasers are very useful as exposure light sources when forming printing plates directly from digital data of computers or the like.

Materials which can be used for positive type planographic printing plate precursors applicable for infrared lasers include, as essential components, a binder resin soluble in an aqueous alkaline solution (hereinafter referred to where appropriate as an “alkali-soluble resin”), and an infra red dye which absorbs light to generate heat. When an image is formed in a positive type planographic printing plate precursor, the infra red dye interacts with the binder resin in its unexposed portions (image portions) so as to function as a dissolution inhibitor which can substantially reduce the solubility of the binder resin. On the other hand, in its exposed portions (non-image portions), interaction of the infra red dye with the binder resin is weakened by the heat generated. Consequently, an exposed portion can turn into a state in which it can be dissolved in an alkaline developer, so that an image is formed thereon and a planographic printing plate is produced.

However, insofar as such infrared-laser-applicable positive planographic printing plate precursor materials are concerned, differences in the degree of resistance against dissolution in a developer between unexposed portions (image portions) and exposed portions (non-image portions) therein, that is, differences in development latitude have not yet been sufficient under various conditions of use. Thus, problems have occurred insofar that, with changes in conditions of use of materials, materials have tended to be either excessively developed or inadequately developed.

Further, when using an infrared-laser-applicable positive type planographic printing plate precursor, if the surface state of the unexposed portions of the plate precursor is slightly changed by human finger touching the surface or some other action, the affected unexposed portions (image portions) are dissolved by development to generate marks like scars. As a result, the plate precursor has problems in that the printing resistance thereof deteriorates and the ink-acceptability thereof worsens.

Such problems stem from fundamental differences in plate-making mechanisms between infrared-laser-applicable positive type planographic printing plate precursor materials and positive type planographic printing plate precursor materials from which printing plates are made up by exposure to ultra violet rays.

That is, the positive planographic printing plate material used for plate-making by exposure to UV light comprises a binder resin soluble in an aqueous alkali solution, an onium salt and a quinone diazide compound as essential ingredients. The onium salt and quinone diazide compound act, in light-unexposed regions (image regions), as a dissolution inhibitor by interaction with the binder resin. In light-exposed regions (non-image regions), on the other hand, they act as a dissolution accelerator by generating an acid upon decomposition by light. That is, the onium salt and quinone diazide compound play two roles, that is, the role of dissolution inhibitor and the role of acid generator.

On the other hand, in infrared-laser-applicable positive type planographic printing plate precursor materials, the infra red dye functions only as a dissolution inhibitor of unexposed portions (image portions), and does not promote the dissolution of exposed portions (non-image portions). Therefore, in order to make distinctive the difference in solubility between the unexposed portion and the exposed portion in the a positive planographic printing plate material for infrared laser, it is inevitable to use a that a material having which already has a high solubility in an alkali developing solution is used as the binder resin. There is therefore the case that the state of the plate material before developed becomes unstable.

Various proposals have been offered to solve the above problems. For example, a method has been proposed in which the distribution of an infrared absorbing agent is localized in the layer to improve the discrimination of an image (see, for example, the publication of Japanese Patent Application Laid-Open (JP-A) No. 2001-281856). Although there is something improved in discrimination by this method, the problem concerning scratching resistance on the surface of the recording layer has yet to been still unsolved.

Also, a planographic printing plate precursor has been proposed which is provided with a recording layer, comprising a lower layer containing a sulfonamide type acryl resin, and an upper layer, which contains a water-insoluble and alkali-soluble resin and a light-heat photo-thermo converting agent, and which is improved in solubility in an aqueous alkali solution by exposure to light (see, for example, the publication of JP-A No 11-218914). This type of planographic printing plate precursor produces the effect that, because the lower layer which is highly alkali-soluble is exposed when the recording layer is removed on an exposed portion, an undesired residual film and the like are removed smoothly by an alkali developing agent. and tThe lower layer also functions as an insulating layer, so that thermal diffusion to the support is efficiently suppressed. In the planographic printing plate precursor of this type, a method has been proposed in which a polymer is blended in the lower layer to provide chemical resistance (see, for example, a leaflet of International Publication (W/O) No. 01/46318).

However, in order to form the multilayer structure, it is essential to select, as the resins used in both layers, those which differing in characteristics from each other, giving rise to the problem that the interaction between these resins is may be reduced. Also, because the developing characteristics of the lower layer are so good, there is a possibility that an undesired dissolution phenomenon occurs at both end portions of the lower layer during developing, which adversely affects printing durability and image reproducibility. Therefore, there is ample room to make good use of the merits of a multilayer structure.

### SUMMARY OF THE INVENTION

The present invention is made in view of the above circumstances and provides a positive planographic printing plate precursor for infrared lasers for direct plate-making excellent in scratch resistance and in discrimination of a formed image and a method of producing the same.

The inventors made extensive investigations, and as a result, they found that the problem described above can be solved by arranging positive recording layers in a layered structure and conferring anisotropy of solubility to an aqueous alkali solution of the recording layer near to the support with respect to the depth and lateral directions, thereby completing the invention.

That is, the planographic printing plate precursor in the first aspect of the invention comprises a support and a positive recording layer arranged on the support. the positive recording layer containing resin and an infrared absorber and being constituted of two or more sub-layers, wherein the solubility of the positive recording layer to an aqueous alkali solution is increased by exposure to infrared laser light, and for the positive recording sub-layer of the two or more positive recording sub-layers that is nearest to the support, the ratio of the dissolution speed to an aqueous alkali solution in the lateral direction to the dissolution speed in the depth direction is less than 1.

The method in the second aspect of the invention for producing the planographic printing plate precursor of the first aspect of the invention, comprises: (a) forming the positive recording sub-layer of the two or more positive recording sub-layers that is nearest to the support, and (b) forming another positive recording sub-layer adjacent to the positive recording sub-layer nearest to the support, wherein process (a) includes forming a dispersed phase in the positive recording sub-layer nearest to the support, and/or drying at high temperature the positive recording sub-layer nearest to the support thus formed.

In the specification, the “positive recording sub-layer nearest to a support” is referred to hereinafter as “lower layer” or “lower recording layer” as necessary. Further, the “positive recording sub-layers” may occasionally be referred to hereinafter simply as “positive recording layers”.

In the planographic printing plate precursor of the invention, not only a plurality of the positive recording sub-layers but also other layers, such as surface protective, undercoat, intermediate and back coat layers can be arranged on the support as required, as long as the effect of the invention is not hindered.

Specifically, a method of making the ratio of the dissolution speed in the lateral direction to the dissolution speed in the depth direction of the lower layer in an aqueous alkali solution to be less than 1 includes, for example, the following methods.

(I) Method of forming a dispersed phase in the lower layer such that the solubility of the dispersed phase is made lower than that of the phase serving as a dispersing medium (referred to hereinafter sometimes as matrix phase). Thus, due to the presence of the dispersed phase having lower solubility, it is possible to inhibit development of the recording layer from proceeding in the lateral direction. In the depth direction, on the other hand, the solubility of light-exposed portions is increased due to heat sensitivity exhibited in the dispersed phase. It is thought that since an anisotropy of dissolution speed can be exhibited, the sharpness of an image is improved, which results in being able to maintain the performance of the material, and in particular the sensitivity.

In this case, anisotropy is increases as the shape of the dispersed phase is made longer in the direction parallel to the substrate. From the viewpoint of forming such a dispersed phase, it is preferable to use a coating system using the application of stress to a coating solution or a method of forming a coating film where the evaporation time of the solvent in the coating solution is short. Such methods include bar coating, and methods of shortening the evaporation time of a solvent includes a method that involves regulating the drying temperature and the amount of drying air.

Such a dispersed phase can be formed for example by a method wherein:

(1) a combination of two resins that are not mutually soluble is used, or

(2) a granular polymer selected from microcapsules and latexes is dispersed in a matrix resin.

(II) Method of high-temperature drying in forming the lower layer. It is considered that by drying the lower layer at a high temperature, many of the ionic bonds necessary for exhibiting heat sensitivity can be made, thereby allowing heat sensitivity to be expressed in the lower layer and thereby exhibiting anisotropy.

A system of utilizing a change in the solubility to an aqueous alkali solution of the recording layer is used in the planographic printing plate precursor of the invention, so in a preferable mode, the resin used in the positive recording layer comprises a resin insoluble in water and soluble in an aqueous alkali solution.

In the invention, from the viewpoint of ease of production, for the method of making the ratio of the dissolution speed of the lower layer in the lateral direction to the dissolution speed in the depth direction to be less than 1 is preferably the method (I)-(1), that is, the method of combining two resins which are not mutually soluble to form a dispersed phase in the lower layer. For the two resins, those which are not mutually soluble may be selected, or resins which dissolved uniformly in a coating solvent but which form a dispersed phase along with the removal of the solvent when forming the recording layer may be used.

It is preferable that in the lower recording layer, the resin which forms a matrix phase from among the two or more resins used, comprises a polymer compound insoluble in water and soluble in an aqueous alkali solution, while the dispersed phase contains a compound which generates an acid or radical by irradiation with an infrared laser. Alternatively, it is preferable that the resin forming the matrix phase comprises a polymer compound insoluble in water and soluble in an aqueous alkali solution, while the dispersed phase contains a compound having alkali solubility changed by irradiation with an infrared laser.

The size of the dispersed phase is established preferably such that the maximum major axis is 0.1 to 0.8 μm, and the average major axis is 0.05 to 0.6 μm. The size of the dispersed phase can be evaluated by cutting the recording layer with a microtome or the like to give sections of the photosensitive layer, then making the sections electroconductive, taking a photograph thereof with a scanning electron microscope (SEM) and evaluating the size of the circular or elliptical dispersed phase by an image analyzer.

When the method (I)-(1) is used in the invention, a dispersed phase, having solubility to an aqueous alkali solution that is increased by heating or with light, is arranged in a resin matrix phase in the lower layer, whereby the alkali solubility of the dispersed phase is increased in light-exposed regions. That is, aqueous alkali-permeable paths are formed in the matrix, thus accelerating the dissolution of the alkali-soluble resin matrix in the light-exposed regions of the lower layer.

In light-unexposed regions (image regions), on the other hand, because the solubility of the dispersed phase in an alkali developing solution is low due to the inherent properties thereof, the permeation of an aqueous alkali solution in the resin matrix phase in the lower layer, particularly the permeation from the side (in the lateral direction), can be efficiently suppressed. That is, the aqueous alkali solution can be prevented from damaging the image regions, thus enabling formation of sharp images excellent in image discrimination.

This characteristic is particularly significant in high-resolution images having a small image area, and therefore, the planographic printing plate precursor of the invention is particularly useful in high-resolution images of FM screens, increasingly used with the proliferation of computer-to-plate (CTP) techniques in recent years. Accordingly, the planographic printing plate precursor of the invention can be used preferably in formation of images by commercially available FM screens such as Staccato (trade name, manufactured by Creo), Fairdot/Spekta and Randot (trade names, manufactured by Dainippon Screen Co., Ltd.) and Co-Res screen (trade name, manufactured by Fuji Photo Film Co., Ltd.).

The invention provides a positive planographic printing plate precursor for infrared laser for direct plate making, which is excellent in scratch resistance and excellent in discrimination of images formed, as well as a method of producing the same. Accordingly, the plate-making stability for particularly high-resolution images can be improved according to the invention. Here “high-resolution images” encompass FM screen images increasingly used with the proliferation of CTP techniques in recent years.

### BRIEF DESCRIPTION OF THE DRAWINGS

FIG. 1 is a graph showing one example of an alternating current waveform used in electrochemical surface roughening treatment in preparation of a support used in the planographic printing plate precursor of the invention.

FIG. 2 is a side view showing one example of a radial cell for electrochemical surface roughening treatment using alternating current in the preparation of a support for the planographic printing plate of the invention.

### DETAILED DESCRIPTION OF THE INVENTION

Hereinafter, the present invention will be described in detail.

The planographic printing plate precursor of the invention comprises a support and two or more positive recording layers arranged on the support each containing resin and infrared absorber, wherein the solubility of the positive recording layers in an aqueous alkali solution is increased by exposure to an infrared laser light, and the ratio of the dissolution speed to an aqueous alkali solution of the positive recording layer nearest to the support in the lateral direction to the dissolution speed in the depth direction is less than 1. The ratio of the dissolution speed is preferably 0.9 or less, and more preferably 0.85 or less.

The method of regulating the ratio of the dissolution speed of the lower layer so as to satisfy the conditions described above include (I) a method of forming a dispersed phase in the lower layer and (II) a method of high-temperature drying in forming the lower layer.

In the invention, the “ratio of the dissolution speed to an aqueous alkali solution in the lateral direction to the dissolution speed in the depth direction” can be determined in the following manner. In the invention, “the depth direction” refers to the direction from the surface of the recording layer toward the support.

1. Dissolution Speed in the Lateral Direction

The planographic printing plate precursor is formed and then exposed to an infrared laser, used to draw a predetermined test pattern imagewise thereon, and dipped in a predetermined alkali developing solution (solution temperature 30° C.) for a dipping time of 0 to 12 seconds, and the edge of the resulting image is observed under an electron microscope (Hitachi S-800 manufactured by Hitachi, Ltd.), and by plotting the dwindling of the edge against time, the dissolution speed is determined, and this is the dissolution speed in the lateral direction.

The conditions of light exposure and the developing solution used are selected appropriately depending on the formulation of the image recording image layer, and the dissolution speed in the lateral direction and the dissolution speed in the depth direction are measured under the same conditions.

In the invention, typically a test pattern (50% 175 lpi) is formed with a beam intensity of 9 W at a drum revolution of 150 rpm with a Trendsetter manufactured by Creo, and a developing solution DT-2 (diluted to DT-2:water=1:8) manufactured by Fuji Photo Film Co., Ltd. is used.

2. Dissolution Speed in the Depth Direction

A sample having a lower layer applied onto a support is prepared and then dipped for a dipping time of 0 to 30 seconds in the same alkali developing solution (solution temperature 30° C.) as used in measurement for the dissolution speed in the lateral direction, and the color density of the coating remaining on the support is measured with a reflection densitometer (manufactured by Gretag), and the thickness of the coating is calculated from the measured density, and the speed in the depth direction is calculated from the time required for dissolution.

3. Calculation of the Rate of Dissolution Speed
Dissolution speed in the lateral direction=(((the theoretical length of side for 50% 175 lpi)−(side length after 12 seconds))/2)/12
Speed in the depth direction=thickness of the lower layer/time required for dissolution

Using these numerical values, the ratio of dissolution speeds is calculated according to the following equation:
Ratio of dissolution speeds(dissolution anisotropy)=(speed in the lateral direction/speed in the depth direction)

Hereinafter, the method (I) of forming a dispersed phase in the lower layer will be described.

The method (I) of forming a dispersed phase in the lower layer includes 2 methods as described above. First, the dispersed phase obtained by the method (1) is described.

This method is a method of forming a matrix phase (that is, a dispersing medium) and a dispersed phase by using two or more resins (polymer compounds) that are not mutually soluble, and at least one of the two or more non mutually soluble polymer compounds is a polymer insoluble in water and soluble in an aqueous alkali solution, and this polymer is preferably the polymer compound forming the matrix phase. The phrase “not mutually soluble” means that the combination of the two or more polymers does not outwardly appear as a one-phase solid or liquid, this being confirmed by suitably processing of sections of the recording layer, and visually examining the sections or taking photographs of the sections with a scanning electron microscope and observing them.

For improving dissolution anisotropy, it is preferable that the dispersed phase constituting a sea island structure of the lower layer is formed such that the maximum major axis is 0.7 μm or less, and the average major axis is 0.5 μm or less. Selection of a coating solvent is an important factor for formation of the dispersed phase of such size, and by using a suitable coating solvent system, a sea island structure having the target size can be formed. The method of measuring the size of the dispersed phase will be described below in detail.

It is known that in addition to the aforementioned coating solvent type, the condition under which a coating layer that has not yet been dried (after the photosensitive coating solution is applied) is dried is an important factor to allow the dispersion phase constituting the island structure in the lower layer to have a specified size. The descriptions in the publication of JP-A No. 9-90610 may be adopted as a reference for the production of such an island structure.

The macromolecular compound used to form the dispersion phase in the case of forming the macromolecular matrix and the dispersion phase by using two or more macromolecular compounds incompatible with each other are shown below.

Examples of the macromolecular compound used in the invention include copolymers having a structural unit derived from at least one of monomers corresponding to the following (1) to (5), or urethane type macromolecular compounds, novolac resins, diazo resins and polyethers.

First, the monomers corresponding to the following (1) to (5) will be described hereinafter.

(1) Examples of the above structural unit include acrylamides, methacrylamides, acrylates and methacrylates having an aromatic hydroxyl group. Specific examples these compounds include N-(4-hydroxyphenyl)acrylamide or N-(4-hydroxyphenyl)methacrylamide, o-, p- or m-hydroxyphenylacrylate or methacrylate and 2-hydroxyethylmethacrylate.

(2) Examples of the above structural unit also include unsaturated carboxylic acids such as acrylic acid, methacrylic acid, maleic acid anhydride and itaconic acid.

(3) Examples of the above structural unit also include low-molecular compounds having at least one sulfonamide group in which at least one hydrogen atom is bonded to a nitrogen atom and at least one polymerizable unsaturated bond, for example, compounds represented by the following formulae (I) to (V).

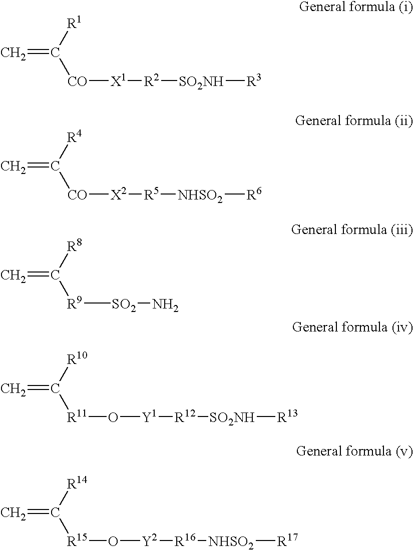

In the general formulae (i) to (v), X¹ and X² each independently represent —O—, or —NR⁷—; R¹ and R⁴ each independently represent a hydrogen atom, or —CH₃; R², R⁵, R⁹, R¹² and R¹⁶ each independently represent an alkylene, cycloalkylene, arylene or aralkylene group which may have a substituent and has 1 to 12 carbon atoms; R³, R⁷ and R¹³ each independently represent a hydrogen atom, or an alkyl, cycloalkyl, aryl or aralkyl group which may have a substituent and has 1 to 12 carbon atoms; R⁶ and R¹⁷ each independently represent an alkyl, cycloalkyl, aryl or aralkyl group which may have a substituent and has 1 to 12 carbon atoms; R⁸, R¹⁰ and R¹⁴ each independently represent a hydrogen atom or —CH₃; R¹¹ and R¹⁵ each independently represent a single bond, or an alkylene, cycloalkylene, arylene or aralkylene group which may have a substituent and has 1 to 12 carbon atoms; and Y¹ and Y² each independently represent a single bond or —CO—.

Specific examples of the compounds represented by the represented by the general formulae (i) to (v) include m-aminosulfonylphenyl methacrylate, N-(p-aminosulfonylphenyl)methacrylamide and N-(p-aminosulfonylphenyl)acrylamide.

(4) Examples of the above structural unit also include low-molecular compounds containing at least one active imino group represented by the following formula (VI) and at least one polymerizable unsaturated bond, for example, N-(p-toluenesulfonyl)methacrylamide and N-(p-toluenesulfonyl)acrylamide.

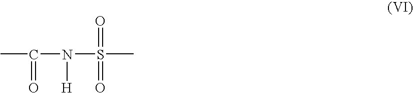

(5) Examples of the above structural unit also include styrene type compounds or vinyl acetate and vinyl alcohol, for example, o-, m- or p-hydroxystyrene, styrene p-sulfonate and o-, m- or p-carboxylstyrene.

The monomers corresponding to the above (1) to (5) may be used either singly or in combinations of two or more. Copolymers obtained by combining these monomers (1) to (5) with monomers other than these monomers (1) to (5) are more preferable. In this case, the structural unit derived from the above monomers (1) to (5) is contained in an amount 10 mol % or more, preferably 20 mol % or more and still more preferably 25 mol % or more. Examples of the monomer used in combination with these monomers (1) to (5) include the following compounds (6) to (16).

(6) Acrylates and methacrylates having an aliphatic hydroxyl group, for example, 2-hydroxyethylacrylate or 2-hydroxyethylmethacrylate.

(7) (Substituted) alkylacrylates such as methylacrylate, ethylacrylate, propylacrylate, butylacrylate, amylacrylate, hexylacrylate, octylacrylate, benzylacrylate, 2-chloroethylacrylate, glycidylacrylate and N-dimethylaminoethylacrylate.

(8) (Substituted) alkylmethacrylates such as methylmethacrylate, ethylmethacrylate, propylmethacrylate, butylmethacrylate, amylmethacrylate, hexylmethacrylate, cyclohexylmethacrylate, benzylmethacrylate, glycidylmethacrylate and N-dimethylaminoethylmethacrylate.

(9) Acrylamide or methacrylic acid amides such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide and N-ethyl-N-phenylacrylamide.

(10) Vinyl ethers such as ethyl vinyl ether, 2-chloroethyl vinyl ether, hydroxyethyl vinyl ether, propyl vinyl ether, butyl vinyl ether, octyl vinyl ether and phenyl vinyl ether.

(11) Vinyl esters such as vinyl acetate, vinyl chloroacetate, vinyl butyrate and vinyl benzoate.

(12) Styrenes such as styrene, α-methylstyrene, methylstyrene and chloromethylstyrene.

(13) Vinyl ketones such as methyl vinyl ketone, ethyl vinyl ketone, propyl vinyl ketone and phenyl vinyl ketone.

(14) Olefins such as ethylene, propylene, isobutylene, butadiene and isoprene.

(15) N-vinylpyrrolidone, N-vinylcarbazole, 4-vinylpyridine, acrylonitrile and methacrylonitrile.

(16) Unsaturated imides such as maleimide, N-acryloylacrylamide, N-acetylmethacrylamide, N-propionylmethacrylamide and N-(p-chlorobenzoyl)methacrylamide.

Furthermore, monomers polymerizable with the above monomers may be copolymerized. As these macromolecular compounds, those having a weight average molecular weight of 2000 or more and a number average molecular weight of 1000 or more are preferably used. The macromolecular compound is more preferably those having a weight average molecular weight of 5000 to 300000, a number average molecular weight of 2000 to 250000 and a degree of dispersion (weight average molecular weight/number average molecular weight) of 1.1 to 10.

Now, the urethane-based polymer compound, novolak resin, diazo resin, and polyethers will be described.

Examples of the water-insoluble and aqueous alkali solution-soluble urethane type macromolecular compound include, though not limited to, urethane type macromolecular compounds described in each publication of JP-A Nos. 63-124047, 63-287946, 2-866 and 2-156241.

In the invention, the above acryl type macromolecular compound may be used together with the urethane macromolecular compound.

Examples of the alkali-soluble novolac resin used in the invention may include alkali-soluble novolac resins such as a phenolformaldehyde resin, m-cresolformaldehyde resin, p-cresolformaldehyde resin, m-/p-mixed cresolformaldehyde resin and phenol/cresol (any of m-, p- and m-/p-mixture) mixed formaldehyde resin. As these alkali-soluble novolac resins, those having a weight average molecular weight of 500 to 20000 and a number average molecular weight of 200 to 10000 are used. Further, a condensate of a phenol having an alkyl group having 3 to 8 carbon atoms as a substituent and formaldehyde such as a t-butylphenolformaldehyde resin and octylphenolformaldehyde resin may be used together.

Also, as the diazo resin used in the invention, a diazo resin, namely, a polymer or oligomer having a diazonium group as its side chain is preferably used. Particularly, diazo resins which are condensates of aromatic diazonium salts and, for example, active carbonyl-containing compounds (e.g., formaldehyde) are useful. Preferable examples of the diazo resin include reaction products of anions and condensates obtained by condensing the following diazo monomers with a condensing agent such as formaldehyde, acetaldehyde, propionaldehyde, butylaldehyde, isobutylaldehyde and benzaldehyde in ratio by mol of 1:1 to 1:0.5 and preferably 1:0.8 to 1:0.6 by using a usual method: examples of the aforementioned diazo monomers include 4-diazo-diphenylamine, 1-diazo-4-N,N-dimethylaminobenzene, 1-diazo-4-N,N-diethylaminobenzene, 1-diazo-4-N-ethyl-N-hydroxyethylaminobenzene, 1-diazo-4-N-methyl-N-hydroxyethylaminobenzene, 1-diazo-2,5-diethoxy-4-benzoylaminobenzene, 1-diazo-4-N-benzylaminobenzene, 1-diazo-4-morpholinobenzene, 1-diazo-2,5-dimethoxy-4-p-tolylmercaptobenzene, 1-diazo-2-ethoxy-4-N,N-dimethylaminobenzene, 1-diazo-2,5-dibutoxy-4-morpholinobenzene, 1-diazo-2,5-dimethoxy-4-morpholinobenzene, 1-diazo-2,5-diethoxy-4-morpholinobenzene, 1-diazo-2,5-diethoxy-4-p-tolylmercaptobenzene, 1-diazo-3-ethoxy-4-N-methyl-N-benzylaminobenzene, 1-diazo-3-chloro-4-N,N-diethylaminobenzene, 1-diazo-3-methyl-4-pyrrolidinobenzene, 1-diazo-2-chloro-4-N,N-dimethylamino-5-methoxybenzene, 1-diazo-3-methoxy-4-pyrrolidinobenzene, 3-methoxy-4-diazodiphenylamine, 3-ethoxy-4-diazodiphenylamine, 3-(n-propoxy)-4-diazodiphenylamine and 3-isopropoxy-4-diazodiphenylamine.

Examples of the anions may include boron tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, di-t-butylnaphthalenesulfonic acid, 1-naphthol-5-sulfonic acid, 2-methoxy-4-hydroxy-5-benzoyl-benzenesulfonic acid and paratoluenesulfonic acid. Among these compounds, hexafluorophosphoric acid and alkyl aromatic sulfonic acids such as triisopropylnaphthalenesulfonic acid and 2,5-dimethylbenzenesulfonic acid are particularly preferable.

Also, reaction products between the aforementioned anions and condensates obtained from the aforementioned diazomonomers and carboxylic acids and/or aldehydes having a phenol or its acetal (and further the aforementioned condensing agents according to the need) and diazo resins as described in each publication of JP-A Nos. 1-102456 and 1-102457 are preferably used in the invention. Particularly, the diazo resins containing a carboxylic acid group are preferable because they improve developing characteristics with the result that a non-image portion when carrying out printing is scarcely soiled.

Among these diazo resins, diazo resins which have the structural unit represented by the following formula (1) or the structural unit represented by the following formulae (1) and (2) and a weight average molecular weight of 500 or more, preferably 800 or more and more preferably 1000 or more are most preferable from the viewpoint that the decomposability of these resins and the preserving stability of the resulting planographic printing plate precursor are both good. When the weight average molecular weight is less than 500, the layer strength of an image portion is reduced. The ratio (weight ratio) of the structural units represented by the formulae (1) and (2) is preferably 100:0 to 30:70. If the amount of the structural unit represented by the formula (1) is reduced, the strength of an image portion is reduced. The diazo resin used in the invention may contain other structure unit.

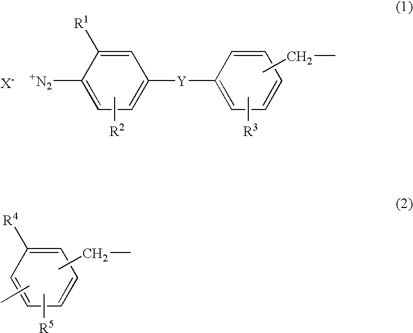

wherein R¹, R², R³, R⁴ and R⁵ respectively represent hydrogen, a halogen (for example, fluorine, chlorine or bromine), —COOH, —OPO₃H₂, —PO₃H₂, —SO₃H, —OH, a hydrocarbon group which may have a substituent (for example, —COOH, —OPO₃H₂, —PO₃H₂, —SO₃H or —OH) (for example, a carboxymethyl group, a hydroxyethyl group or a p-carboxymethoxyphenyl group), an alkoxy group (for example, a methoxy group, a hexyloxy group or a carboxymethoxy group) or an aryloxy group (for example, a phenoxy group or a p-carboxymethoxyphenoxy group), Y represents NR⁶, O or S, R⁶ represents hydrogen or a hydrocarbon group having 12 or less carbon atoms (for example, a methyl group, an ethyl group or a hexyl group). Also, X⁻ represents PF₆⁻ or a benzene sulfonate or a naphthalene sulfonate which may have a substituent having 20 or less carbon atoms. Examples of the substituent include a methyl group, butyl group (including n-, i-, sec- or t-butyl group), hexyl group, decyl group, dodecyl group and benzoyl group.

When a lower recording layer comprising a polymer matrix containing a dispersed phase formed from 2 or more of these polymer compounds is a positive recording layer, an infrared absorber and a compound having alkali solubility changed by heating are contained in a high content level in the dispersed phase, thereby exhibiting efficient heat sensitivity to enable regulation of the ratio of dissolution speed.

When the two or more polymer compounds are used to form a lower recording layer in the presence of the infrared absorber, a dispersed phase is formed in the polymer binder, and a high amount of the infrared absorber becomes contained in the dispersed phase. When two or more polymer compounds not mutually soluble are used to form a binder layer, the polymer which shows a stronger interaction due to hydrogen bonding, ionic properties etc., easily forms spheres or flat spheres in the binder. Such localization described above occurs because when an infrared absorber is present in the dispersed phase, the infrared absorber is ionic or a coordination complex and is thus more easily incorporated into the polymer compound showing stronger interaction in the binder. When an acid generator or a radical generator (polymerization initiator) is made to be coexistent, the initiator usually has a high polar group such as in an onium salt structure, triazine or sulfonate ester, and, similar to the infrared absorber, is easily incorporated into the dispersed phase.

Here, when two or more types of incompatible macromolecular compounds are used to form the lower recording layer, if a dispersion phase is formed in a macromolecular matrix phase as the dispersion medium, which is a dispersion medium when two or more incompatible high-molecular compounds are used to form the lower recording layer, this structure is referred to as an island structure. In the invention, the island structure can be observed and evaluated in the following manner: the a section of the recording layer obtained by cutting the planographic printing plate precursor by a microtome or the like is made to have conductiveity and then a photographan image of the section is taken by a scanning type electron microscope (SEM) to analyze the size of a circular or elliptic dispersion phase by using an image analyzer.

When the image on the taken photograph taken is blurred, the section of the photosensitive layer is treated, for example, by etching with solvent and then a photograph of the section is taken according to the method described in, for example, “Polymer Alloy and Polymer Blend” (L. A. UTRACKI, translated by Toshio NISHI, Tokyo Kagaku Dojzin), the disclosure of which is incorporated by reference herein, to thereby obtain a highly distinct image.

Hereinafter, a preferable method of forming a dispersed phase in the lower layer will be described.

In the invention, selection of a coating solvent is an important factor in order that the dispersed phase constitutes a sea island structure of the lower layer with a maximum major axis of 0.7 μm or less and average major axis of 0.5 μm or less, for the purpose of improving dissolution anisotropy. By using a suitable coating solvent system, a sea island structure having the target size can be formed.

A clear mechanism has not been found out as to the reason why the size of the dispersion phase is reduced or varied by the selection of a coating solvent system. A ketone type solvent such as cyclohexanone or methyl ethyl ketone, alcohol type solvent such as methanol, ethanol, propanol or 1-methoxy-2-propanol, cellosolve type solvent such as ethylene glycol monomethyl ether, lactone type solvent such as γ-butyrolactone, sulfoxide type such as dimethyl sulfoxide or sulfolane, halogen type solvent such as ethylene dichloride, acetate type solvent such as 2-methoxyethyl acetate or 1-methoxy-2-propyl acetate, ether solvent type such as dimethoxyethane, ester type solvent such as methyl lactate or ethyl lactate, amide type solvent such as N,N-dimethoxyacetamide or N,N-dimethylformamide, pyrrolidone type solvent such as N-methylpyrrolidone, urea type solvent such as tetramethylurea or aromatic type solvent such as toluene is preferably used as the coating solvent. Among these compounds, methyl ethyl ketone, 1-methoxy-2-propanol, ethylene glycol monomethyl ether, γ-butyrolactone and dimethyl sulfoxide are preferable. These solvents may be used either singly or by mixing two or more.

It is known that in addition to the aforementioned coating solvent type, the condition under which a coating layer that has not yet been dried (after the photosensitive coating solution is applied) is dried is an important factor to allow the dispersion phase constituting the island structure in the lower layer to have a specified size. The descriptions in the publication of JP-A No. 9-90610 may be adopted as a reference for the production of such an island structure.

The macromolecular compound used to form the dispersion phase in the case of forming the macromolecular matrix and the dispersion phase by using two or more macromolecular compounds incompatible with each other are shown below.

The lower recording layer comprising a macromolecular matrix containing a dispersion phase formed in this manner, when it is a positive recording layer, contains an infrared absorbing agent and a compound which is changed in solubility in an aqueous alkali solution by heat, in a high content in the dispersion phase, to thereby improve the solubility of the macromolecular matrix layer in an aqueous alkali.

Next, the dispersion phase (I)-(2) of the invention will be explained. In the granular polymer such as a microcapsule or latex which is used in the invention, the microcapsule can be easily prepared by the method described in the examples of the publication of JP-A No. 1-145190 or the method described in “NEW EDITION, MICROCAPSULE-ITS PREPARATION, NATURE AND APPLICATION” published by Sankyo Shuppan. As to the latex, the latex or production method in each publication of JP-A Nos. 10-265710, 10-270233 and 5-2281 and “CHEMISTRY OF MACROMOLECULAR LATEX” issued from Polymer Publishing Association and “MACROMOLECULAR LATEX” published by New Polymer Library may be used to prepare the latex used in the invention.

The microcapsules are usually spherical, so for exhibiting the dissolution anisotropy in the invention, the sphere diameter (dispersed phase) is preferably 0.5 μm or less. The diameter is more preferably 0.3 μm or less. The added amount of the microcapsules is 2 to 30 wt %, preferably 5 to 20 wt %, more preferably 8 to 15 wt %, based on the whole coating film.

At this time, examples of materials included in the capsule or in the latex include an acid generator, initiator such as a radical generator, light-heat converting material or a crosslinking agent. Also, as the macromolecular compound which may be used as the macromolecular matrix for layer formation in the lower layer having the dispersion phase (I)-(2), the compounds exemplified in the aforementioned embodiment of the dispersion phase (1) may be likewise used.

Next, each compound contained in the dispersion phase will be explained.

The dispersion phase may include an acid generator that is decomposed by light or heat to generate an acid, to improve the solubility of the aqueous alkali-soluble macromolecular compound of an exposed portion in aqueous alkali.

The acid generator represents those that are decomposed by irradiation with light having a wavelength of 200 to 500 nm or by heating at 100° C. or more. Examples of the acid generator include a photoinitiator for photo-cationic polymerization, photoinitiator for photo-radical polymerization, photo-achromatizing agent for dyes, photo-discoloring agent, known acid generator used for micro-resist, known compound which is thermally decomposed to generate an acid and a mixture of these compounds. As the acid to be generated is preferably a strong acid having a pKa of 2 or less such as sulfonic acid and hydrochloric acid.

Preferable examples of the initiator include the triazine compounds described in the publication of JP-A No. 11-95415 and the latent Bronsted acid described in the publication of JP-A No. 7-20629. Here, the latent Bronsted acid means a precursor that is to be decomposed to generate a Bronsted acid. It is assumed that the Bronsted acid catalyzes a matrix generating reaction between a resol resin and a novolac resin. Typical examples of the Bronsted acid fitted to this purpose include trifluoromethanesulfonic acid and hexafluorophosphonic acid.

An ionic latent Bronsted acid may be preferably used in the invention. Examples of the ionic latent Bronsted acid include onium salts, particularly, iodonium, sulfonium, phosphonium, selenonium, diazonium and arsonium salts. Particularly useful and specific examples of the onium salt include diphenyliodonium hexafluorophosphate, triphenylsulfonium hexafluoroantinonate, phenylmethyl-ortho-cyanobenzylsulfoniumtrifluoromethane sulfonate and 2-methoxy-4-aminophenyldiazonium hexafluorophosphate.

Nonionic latent Bronsted acids are also appropriately used in the invention. Examples of these nonionic latent Bronsted acids include compounds represented by the following formula:

RCH₂X, RCHX₂, RCX₃, R(CH₂X)₂ and R(CH₂X)₃ (wherein X represents Cl, Br, F or CF₃SO₃ and R represents an aromatic group, an aliphatic group or a combination of an aromatic group and an aliphatic group).

Useful ionic latent Bronsted acid is those represented by the following formula.
X⁺R¹R²R³R⁴W⁻

In the formula, R³ and R⁴ respectively represent a lone electron pair and R¹ and R² respectively represent an aryl or substituted aryl group when X is iodine. When X is S or Se, R⁴ represents a lone electron pair and R¹, R² and R³ respectively represent an aryl group, a substituted aryl group, an aliphatic group or substituted aliphatic group. When X is P or As, R⁴ represents an aryl group, a substituted aryl group, an aliphatic group or a substituted aliphatic group. W represents BF₄, CF₃SO₃, SbF₆, CCl₃CO₂, ClO₄, AsF₆, PF₆ or may be any corresponding acid having a pH less than 3. All the onium salts described in the specification of U.S. Pat. No. 4,708,925 may be used as the latent Bronsted acid used in the invention. Examples of these onium salts include indonium, sulfonium, phosphonium, bromonium, chloronium, oxysulfoxonium, oxysulfonium, sulfoxonium, selenonium, telluronium and arsonium.

It is particularly preferable to use a diazonium salt as the latent Bronsted acid. These diazonium salts provide a sensitivity equivalent to that of other latent Bronsted acids in the infrared region and a higher sensitivity than other latent Bronsted acid in the ultraviolet region.

In the invention, these acid generators are added in a proportion of 0.01 to 50% by weight, preferably 0.1 to 25% by weight and more preferably 0.5 to 20% by weight from the viewpoint of image forming characteristics and from the viewpoint of preventing a non-image portion from being contaminated.

Next, other components which may be used in the positive-type recording layer will be described hereafter.

The positive recording layer in the invention contains an infrared absorbing agent that is a structural component developing a light-heat converting function. This infrared absorbing agent has the ability to convert absorbed infrared rays into heat. Laser scanning causes the infrared absorbing agent to lose the interaction, a developing inhibitor to decompose and generates an acid, which significantly improves the solubility of the infrared absorbing agent. Also, there is also the case where the infrared absorbing agent itself interacts with the alkali-soluble resin to suppress alkali-solubility.

It is considered that the inclusion of such an infrared absorbing agent within the dispersion phase of the lower layer results in the localization of the infrared absorbing agent in the dispersion phase, and resultantly promotes interaction releasability and improves the ability to decompose an acid generator when this acid generator is contained (an infrared absorbing agent is generally included in the upper recording layer in order to form a positive image).

The infrared absorbing agent used in the invention is dyes or pigments which efficiently absorb infrared rays having a wavelength from 760 nm to 1200 nm and is preferably dyes or pigments having an absorption maximum in a wavelength range from 760 nm to 1200 nm.

The infrared absorbing agent which can be used preferably for the planographic printing plate precursor of the invention will be hereinafter explained in detail.

The dyes may be commercially available ones and known ones described in publications such as “Dye Handbook” (edited by the Society of Synthesis Organic Chemistry, Japan, and published in 1970). Specific examples thereof include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium dyes, metal thiolate complexes, and the like.

Preferable examples of the dye include cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squalirium dyes described in JP-A No. 58-112792; and cyanine dyes described in GB Patent No. 434,875.

Other preferable examples of the dye include near infrared absorbing sensitizers described in U.S. Pat. No. 5,156,938; substituted arylbenzo(thio)pyrylium salts described in U.S. Pat. No. 3,881,924; trimethinethiapyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063, and 59-146061; cyanine dyes described in JP-A No. 59-216146; pentamethinethiopyrylium salts described in U.S. Pat. No. 4,283,475; and pyrylium compounds described in Japanese Patent Application Publication (JP-B) Nos. 5-13514 and 5-19702.

Additional preferable examples of the dye include near infrared absorbing dyes represented by formulae (I) and (II) as described in U.S. Pat. No. 4,756,993.

Among these dyes, particularly preferable are cyanine dyes, phthalocyanine dyes, oxonol dyes, squalirium dyes, pyrylium salts, thiopyrylium dyes, and nickel thiolate complexes.

The pigment used as the infrared absorbent in the invention may be a commercially available pigment or a pigment described in publications such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black. Among these pigments, carbon black is preferable.

These pigments may be used with or without surface treatment. Examples of surface treatment include a method of coating the surface of the pigments with resin or wax; a method of adhering a surfactant onto the surface; and a method of bonding a reactive material (such as a silane coupling agent, an epoxy compound, or a polyisocyanate) to the pigment surface. The surface treatment methods are described in “Nature and Application of Metal Soap” (Saiwai Shobo), “Printing Ink Technique” (by CMC Publishing Co., Ltd. in 1984). And “Latest Pigment Applied Technique” (by CMC Publishing Co., Ltd. in 1986.

The particle size of the pigment is preferably from 0.01 to 10 μm, more preferably from 0.05 to 1 μm, and even more preferably from 0.1 to 1 μm. When a particle size is within the preferable range, a superior dispersion stability of the pigment in the photosensitive composition can be obtained, whereby, when the photosensitive composition of the invention is used for a recording layer of the photosensitive printing plate precursor, it is possible to form a homogeneous recording layer.

The method for dispersing the pigment may be a known dispersing technique used to produce ink or toner. Examples of a dispersing machine, which can be used, include an ultrasonic disperser, a sand mill, an attriter, a pearl mill, a super mill, a ball mill, an impeller, a disperser, a KD mill, a colloid mill, a dynatron, a three-roll mill, and a pressing kneader. Details are described in “Latest Pigment Applied Technique” (by CMC Publishing Co., Ltd. in 1986).

In the case of a positive recording layer like this, the infrared absorbing agent is preferably a dye. Particularly preferable examples of the dye include infrared absorbing agents having an onium salt structure as described in the publication of JP-A No. 11-291652, Paragraphs No. [0018] to [0034].

The planographic printing plate precursor of the invention has a positive recording layer. It is therefore preferable to use an infrared absorbing agent which causes a positive action (solubility of an unexposed portion in an alkali developer is suppressed and the suppression of the solubility is cancelled in an exposed portion) by an interaction with a binder polymer having a specific functional group and infrared absorbing agents having an onium salt type structure are particularly preferable in this point. Specifically, among the aforementioned absorbers, cyanine dyes and pyrylium salts are particularly preferable. The details of these cyanine dyes and pyrylium salts are as mentioned above.

Moreover, an anionic infrared absorbing agent as described in Japanese Patent Application No. 10-237634 is also preferably used. This anionic infrared absorbing agent represents those having no cationic structure but an anionic structure on the mother nucleus of a dye which substantially absorbs infrared rays.

Examples of the anionic infrared absorbing agent include (a-1) anionic metal complexes and (a-2) anionic phthalocyanines.

Here, the anionic metal complex (a-1) represents those in which the core metal and the ligands in the complex part that substantially absorbs light are an anion as a whole.

The anionic phthalocyanine (a-2) are those in which an anionic group such as a sulfonic acid, carboxylic acid or phosphonic acid group is bonded as a substituent with a phthalocyanine skeleton to form an anion as a whole.

Other examples of the anionic phthalocyanine may include anionic infrared absorbing agents represented by the formula [Ga⁻-M-Gb]ₘX^{m+} (Ga represents an anionic substituent, Gb⁻ represents a neutral substituent. X^{m+} represents a cation having a valency of 1 to m (where m denotes an integer from 1 to 6) including a proton) as described in Japanese Patent Application of No. 10-237634, Paragraphs [0014] to [0105].

The infrared absorbing agent used in the positive recording layer is preferably a dye. Preferable examples of the dye include infrared absorbing agents having an onium salt structure as described in the publication of JP-A No. 11-291652, Paragraphs [0018] to [0034].

Besides the infrared absorbing agent, such as the aforementioned cyanine dye, pyrylium salt and anionic dye, which develop dissolution inhibitive ability, other dyes or pigments may be used together in the recording layer according to the invention, to further improve sensitivity and developing latitude.

In the invention, the infrared absorbing agent is preferably added in an amount of 0.01 to 50% by weight, more preferably 0.1 to 20% by weight and more preferably 0.5 to 15% by weight based on the total solid content in each of the lower recording layer and other recording layers from the viewpoint of image formation characteristics and from the viewpoint of suppressing contamination to a non-image portion.

The infrared absorbing agent may be contained in any of the matrix phase and the dispersion phase or in the both. When desired components such as the initiator and infrared absorbing agent are contained in the latex constituting the aforementioned dispersion phase, the infrared absorbing agent may be added together with the raw materials when the latex particles are formed or may be introduced after the latex is formed.

Examples of the method of introducing the infrared absorbing agent after the latex is formed include a method in which desired components such as the initiator, color systems and crosslinking agent to be introduced in the latex dispersed in a water system are dissolved in an organic solvent, which is then added in the dispersion medium.

Among the positive recording layers in the planographic printing plate precursor of the invention, the upper recording layer will be described now. The upper recording layer contains a polymer compound insoluble in water and soluble in an aqueous alkali solution, and a compound inhibiting alkali solubility. By exposure to infrared laser light, the ability to inhibit dissolution is released, thus increasing the solubility to an alkali developing solution, and thereby forming an image.

(Alkali-Soluble Polymer)

In the invention, the water-insoluble and aqueous alkali-soluble macromolecular compound (hereinafter referred to as an alkali-soluble polymer as required) which is used in plural positive recording layers includes homopolymers having an acidic group on the principal chain and/or side chain of the polymer, copolymers thereof or mixtures of these polymers. The macromolecular layer according to the invention therefore has the characteristics that it is dissolved when it is brought into contact with an alkali developing solution.

Any known alkali-soluble polymer may be used as the alkali-soluble polymer to be used in the lower recording layer and other recording layers (hereinafter referred to as an upper recording layer as required) in the invention without any particular limitation. However, the alkali-soluble polymer is preferably a macromolecular compound having one functional group selected from (1) a phenolic hydroxyl group, (2) a sulfonamide group and (3) an active imide group in its molecule. The following compounds are given as examples: however, these examples are not intended to be limiting of the invention.

(1) Examples of the macromolecular compounds comprising phenolic hydroxyl group may include novolak resin such as condensation polymers of phenol and formaldehyde; condensation polymers of m-cresol and formaldehyde, condensation polymers of p-cresol and formaldehyde, condensation polymers of m-/p-mixed cresol and formaldehyde, and condensation polymers of phenol/cresol (m-, p-, or m-/p-mixture) and formaldehyde; and condensation copolymers of pyrogallol and acetone. As the macromolecular compound having a phenolic hydroxyl group, it is preferable to use macromolecular compounds having a phenolic hydroxyl group at their side chains besides the above compounds. Examples of the macromolecular compound having a phenolic hydroxyl group at its side chain include macromolecular compounds obtained by homopolymerizing a polymerizable monomer comprising a low-molecular compound having one or more phenolic hydroxyl groups and one or more polymerizable unsaturated bonds or copolymerizing this monomer with other polymerizable monomers.

Examples of the polymerizable monomer having a phenolic hydroxyl group include acrylamides, methacrylamides, acrylates and methacrylates each having a phenolic hydroxyl group or hydroxystyrenes. Specific examples of the polymerizable monomer which may be preferably used include N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenylacrylate, m-hydroxyphenylacrylate, p-hydroxyphenylacrylate, o-hydroxyphenylmethacrylate, m-hydroxyphenylmethacrylate, p-hydroxyphenylmethacrylate, o-hydroxystyrene, m-hydroxystyrene, p-hydroxystyrene, 2-(2-hydroxyphenyl)ethylacrylate, 2-(3-hydroxyphenyl)ethylacrylate, 2-(4-hydroxyphenyl)ethylacrylate, 2-(2-hydroxyphenyl)ethylmethacrylate, 2-(3-hydroxyphenyl)ethylmethacrylate and 2-(4-hydroxyphenyl)ethylmethacrylate. Moreover, condensation polymers of phenols having an alkyl group having 3 to 8 carbon atoms as a substituent and formaldehyde, such as a t-butylphenol formaldehyde resin and octylphenol formaldehyde resin as described in the specification of U.S. Pat. No. 4,123,279 may be used together.

(2) Examples of the alkali-soluble macromolecular compound having a sulfonamide group include macromolecular compounds obtained by homopolymerizing polymerizable monomers having a sulfonamide group or by copolymerizing the monomer with other polymerizable monomers. Examples of the polymerizable monomer having a sulfonamide group include polymerizable monomers comprising a low-molecular compound having, in one molecule thereof, one or more sulfonamide groups —NH—SO₂— in which at least one hydrogen atom is added to a nitrogen atom and one or more polymerizable unsaturated bonds. Among these compounds, low-molecular compounds having an acryloyl group, allyl group or vinyloxy group and a substituted or monosubstituted aminosulfonyl group or substituted sulfonylimino group are preferable.

(3) The alkali-soluble macromolecular compound having an active imide group is preferably those having an active imide group in its molecule. Examples of the macromolecular compound include macromolecular compounds obtained by homopolymerizing a polymerizable monomer comprising a low-molecular compound having one or more active imide groups and one or more polymerizable unsaturated bonds or copolymerizing this monomer with other polymerizable monomers.

As such a compound, specifically, N-(p-toluenesulfonyl)methacrylamide, N-(p-toluenesulfonyl)acrylamide and the like are preferably used.

Moreover, as the alkali-soluble macromolecular compound of the invention, macromolecular compounds obtained by polymerizing two or more types among the aforementioned polymerizable monomers having a phenolic hydroxyl group, polymerizable monomers having a sulfonamide group and polymerizable monomers having an active imide group, or macromolecular compounds obtained by copolymerizing these two or more polymerizable monomers with other polymerizable monomers are preferably used. When a polymerizable monomer having a sulfonamide group and/or a polymerizable monomer having an active imide group is copolymerized with a polymerizable monomer having an active imide group, the ratio by weight of these components to be compounded is preferably in a range from 50:50 to 5:95 and particularly preferably in a range from 40:60 to 10:90.

When the alkali-soluble polymer is a copolymer of the aforementioned polymerizable monomer having a phenolic hydroxyl group, polymerizable monomer having a sulfonamide group or polymerizable monomer having an active imide group and other polymerizable monomers in the invention, it is preferable to contain a monomer imparting alkali-solubility in an amount of 10 mol % or more and more preferably 20 mol % or more. If the copolymer component is less than 10 mol %, the alkali-solubility tends to be unsatisfactory and there is the case where the effect of improving a developing latitude can be attained insufficiently.

Examples of the monomer component to be copolymerized with the aforementioned polymerizable monomer having a phenolic hydroxyl group, polymerizable monomer having a sulfonamide group and polymerizable monomer having an active imide group may include, though not particularly limited to, compounds represented by the following (m1) to (m12).
(m1) Acrylic acid esters and methacrylic acid esters having aliphatic hydroxyl groups such as 2-hydroxyethyl acrylate or 2-hydroxyethyl methacrylate.
(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.
(m3) Alkyl methacrylate such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.
(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacxrylamide.
(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.
(m6) Vinyl esters such as vinyl acetate, vinyl chloroacetate, vinyl butylate, and vinyl benzoate.
(m7) Styrenes such as styrene, α-methylstyrene, methylstyrene, and chloromethylstyrene.
(m8) Vinyl ketones such as methyl vinyl ketone, ethyl vinyl ketone, propyl vinyl ketone, and phenyl vinyl ketone.
(m9) Olefins such as ethylene, propylene, isobutylene, butadiene, and isoprene.
(m10) N-vinylpyrrolidone, acrylonitrile, and methacrylonitrile.
(m11) Unsaturated imides such as maleimide, N-acryloylacrylamide, N-acetylmethacrylamide, N-propionylmethacrylamide, and N-(p-chlorobenzoyl)methacrylamide.
(m12) Unsaturated carboxylic acid such as acrylic acid, methacrylic acid, maleic anhydride, and itaconic acid.

The alkali-soluble macromolecular compound preferably comprises phenolic hydroxyl groups, in terms of the excellent image formability by exposure by infrared laser. Examples the alkali-soluble macromolecular compound comprising phenolic hydroxyl groups include condensed copolymers of phenol and formaldehyde comprising C₃-C₈ alkyl as a substitute, such as tert-butylphenol formaldehyde resin and octylphenol formaldehyde resin described in U.S. Pat. No. 4,123,279.

As a method of copolymerizing the aqueous alkali-soluble macromolecular compound, for example, a conventionally known graft copolymerization method, block copolymerization method or random copolymerization method may be used.

As the alkali-soluble polymer used in the upper recording layer, a resin having phenolic hydroxyl group is desirable in the point that it develops strong hydrogen bonding characteristics in an unexposed portion whereas a part of hydrogen bonds are released with ease in an exposed portion. The alkali-soluble polymer is more preferably a novolac resin. The alkali-soluble resin preferably has a weight average molecular weight of 500 to 20,000 and a number average molecular weight of 200 to 10,000.

The upper recording layer contains the infrared absorber described above and a dissolution inhibitor described later, however when an infrared absorber having an ability to inhibit dissolution, such as a cyanine dye, is used, the dissolution inhibitor is not always necessary.

It is necessary as mentioned above that the recording layer of the planographic printing plate precursor of the invention is highly resistant to abrasion in relation to an infrared laser irradiation system. Any macromolecular material may be used as the macromolecular material which is the binder constituting the recording layer insofar as it is changed in solubility in an aqueous alkali, namely, an alkali developing solution by imparting thermal energy. It is preferable to use a polymer insoluble in water and soluble in aqueous alkali from the viewpoint of availability and resistance to abrasion.

The ceiling temperature of the polymer is given as an example of an index of the abrasion resistance. This ceiling temperature is a temperature at which the rate of a polymerization reaction is equal to the rate of a depolymerization reaction. It is preferable to select polymers having a high ceiling temperature to obtain high abrasion resistance. As a simple method, a proper polymer may be selected using the decomposition temperature thereof as an index.

In the invention, the polymer constituting the recording layer is a polymer having a decomposition temperature of preferably 150° C. or more and more preferably 200° C. or more. When the decomposition temperature is less than 150° C., this is not preferable because the possibility of abrasion is increased.

Also, each component other than the macromolecular compound contained in the recording layer preferably has a decomposition temperature of 150° C. or more. However, as to components contained in a small amount, those having a decomposition temperature less than 150° C. may be used to the extent that the addition of these components gives rise to no substantial problem.

In the recording layer of the planographic printing plate precursor of the invention, not only the constituent components described above but also a wide variety of known additives can be used in combination depending on the application. Among plural recording layers, the lower recording layer should achieve the anisotropy of dissolution to aqueous alkali solution described above. However, other additives as in the other recording layers may basically be used in the lower layer.

[Fluorine-Containing Polymer]

Each recording layer of the invention is preferably compounded of a fluorine polymer for the purpose of improving the developing durability in an image part region. Examples of the fluorine-containing polymer used in an image recording layer include fluorine-containing monomer copolymers as described in each publication of JP-A Nos. 11-288093 and 2000-187318. Preferable and specific examples of the fluorine-containing polymer include fluorine-containing acryl type polymers P-1 to P-13 as described in the publication of JP-A No. 11-288093 and fluorine-containing polymers obtained by copolymerizing fluorine-containing acryl type monomers A-1 to A-33 with optional acryl monomers.

As to the molecular weight of the fluorine-containing polymer exemplified above, a fluorine-containing polymer having a weight average molecular weight of 2000 or more and a number average molecular weight of 1000 or more is preferably used. It is more preferable that the weight average molecular weight be 5000 to 300000 and the number average molecular weight be 2000 to 250000.

Also, as the fluorine-containing polymer, commercially available fluorine type surfactants having the aforementioned preferable molecular weight may be used. Specific examples of these surfactants may include Megafac F-171, F-1173, F-176, F-1183, F-184, F-780 and F-781 (all are trade names).

These fluorine-containing polymers may be used either singly or combinations of two or more.

It is necessary that the amount of the fluorine-containing polymer be 1.4 mass % or more based on the solid content of the image recording layer to meet the requirements in the invention. The amount is preferably 1.4 to 5:0 mass %. When the amount is below 1.4 mass %, the purpose of the addition of the fluorine-containing polymer, namely, the effect of improving the developing latitude of the image recording layer is obtained insufficiently. Even if the fluorine-containing polymer is added in an amount exceeding 5.0 mass %, the effect of bettering the developing latitude is not improved; on the contrary, the solubility of the surface of the image recording layer is made more sparing by the influence of the fluorine-containing polymer and there is a possibility of a decrease in sensitivity.

(Dissolution Inhibitor)

A material (dissolution inhibitor), such as an onium salt, o-quinonediazide compound, aromatic sulfone compound or aromatic sulfonate compound, which is thermally decomposable and substantially reduces the solubility of the aqueous alkali-soluble macromolecular compound in an decomposed state may be added together according to the need in the lower recording layer or other layers according to the invention. The addition of the dissolution inhibitor makes it possible not only to improve the dissolution resistance of the image portion in a developing solution but also to use, as the infrared absorbing agent, a compound which does not interact with the alkali-soluble resin. Examples of the onium salt include diazonium salts, ammonium salts, phosphonium salts, iodonium salts, sulfonium salts, selenonium salts and arsonium salts.

Preferable examples of the onium salt used in the invention include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D. C. Necker et al., Macromolecules, 17, 2468 (1984), C. S. Wen et al., Teh, Proc. Conf. Rad. Curing ASIA, p478 Tokyo, Oct (1988), and U.S. Pat. Nos. 4,069,055 and 4,069,056; iodonium salts described in J. V. Crivello et al., Macromolecules, 10 (6), 1307 (1977), Chem. & Eng. News, Nov. 28, p31 (1988), EP No. 104,143, U.S. Pat. Nos. 5,041,358 and 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 5,041,358, 4,491,628, 4,760,013, 4,734,444 and 2,833,827, and DE Pat. Nos. 2,904,626, 3,604,580 and 3,604,581; selenonium salts described in J. V. Crivello et al., Macromolecules, 10 (6), 1307 (1977), J. V. Crivello et al., J. Polymer Sci., Polymer Chem. Ed., 17, 1047 (1979); arsonium salts described in C. S. Wen et al., and The Proc. Conf. Rad. Curing ASIA, p478, Tokyo, Oct (1988).

In the invention, a diazonium salt is particularly preferable. Particularly preferable diazonium salts include those described in the publication of JP-A No. 5-158230.

Examples of the counter ion of the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and p-toluenesulfonic acid. Among these examples, hexafluorophosphoric acid, and alkylaromatic sulfonic acids such as triisopropylnaphthalenesulfonic acid and 2,5-dimethylbezenesulfonic acid are particularly preferable.

The quinonediazide is preferably an o-quinonediazide compound. The o-quinonediazide compound used in the invention is a compound having at least one o-quinonediazide group and having an alkali-solubility increased by being thermally decomposed. The compound may be any one of compounds having various structures.

In other words, the o-quinonediazide compound assists the solubility of the photosensitive material both from the viewpoint of the effects of being thermally decomposed, and thereby losing the function of suppressing the dissolution of the binder, and the effect that the o-quinonediazide itself is changed into an alkali-soluble material.

Preferable examples of the o-quinonediazide compound used in the invention include compounds described in J. Coser, “Light-Sensitive Systems” (John Wiley & Sons. Inc.), pp. 339-352. Particularly preferable are sulfonic acid esters or sulfonamides of o-quinonediazide made to react with various aromatic polyhydroxy compounds or with aromatic amino compounds.

Further preferable examples include an ester made from benzoquinone-(1,2)-diazidesulfonic acid chloride or naphthoquinone-(1,2)-diazide-5-sulfonic acid chloride and pyrogallol-acetone resin, as described in JP-B No. 43-28403; and an ester made from benzoquinone-(1,2)-diazidesulfonic acid chloride or naphthoquinone-(1,2)-diazide-5-sulfonic acid chloride and phenol-formaldehyde resin.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

Other useful o-quinonediazide compounds are reported in unexamined or examined patent documents, examples of which include JP-A Nos. 47-5303, 48-63802, 48-63803, 48-96575, 49-38701 and 48-13354, JP-B No. 41-11222, 45-9610 and 49-17481, U.S. Pat. Nos. 2,797,213, 3,454,400, 3,544,323, 3,573,917, 3,674,495 and 3,785,825, GB Patent Nos. 1,227,602, 1,251,345, 1,267,005, 1,329,888 and 1,330,932, and DE Pat. No. 854,890.

The amount of the o-quinonediazide compound is preferably in a range from 1 to 50 mass %, more preferably in a range from 5 to 30 mass % and particularly preferably in a range from 10 to 30 mass % based on the total solid content of each recording layer. These compounds may be used as a mixture of plural types though each may be used singly.

The amount of the additives except for o-quinonediazide compound is preferably 1 to 50 mass %, more preferably 5 to 30 mass % and particularly preferably 10 to 30 mass %. The additives and binder used in the invention are preferably compounded in the same layer.

Also, a polymer using, as a polymer component, a (meth)acrylate monomer having two or three perfluoroalkyl group having 3 to 20 carbon atoms in its molecule as described in the specification of JP-A No. 2000-87318 may be used together for the purpose of intensifying the discrimination of an image and increasing resistance to surface damages.

In order to enhance sensitivity, the photosensitive composition may also contain a cyclic acid anhydride, a phenolic compound, or an organic acid.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No. 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphates, and carboxylic acids, which are described in JP-A No. 60-88942 or 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

When the cyclic acid anhydride, the phenol or the organic acid is added to the printing plate material (the recording layer) of a planographic printing plate precursor, the ratio thereof in the recording layer is preferably from 0.05 to 20%, more preferably from 0.1 to 15%, and even more preferably from 0.1 to 10% by mass.

For example, a dye having absorption in the visible light region may be added as a colorant for an image to each recording layer according to the invention. Examples of the dye may include Oil Yellow #101, Oil Yellow #103, Oil Pink #312, Oil Green BC; Oil Blue BOS, Oil Blue #603, Oil Black BY, Oil Black BS and Oil Black T-505 (these products are manufactured by Orient Chemical Industries, Ltd.), Victoria Pure Blue, Crystal Violet (CI42555), Methyl Violet (CI42535), Ethyl Violet, Rhodamine B (CI145170B), Malachite Green (CI42000), Methylene Blue (CI52015) and Aizen Spirol Blue C-RH (manufactured by Hodogaya Chemical Co., Ltd.) and dyes as described in JP-A No. 62-293247.

The addition of these dyes is preferable because discrimination between an image portion and a non-image portion is intensified after an image is formed. The amount of these dyes to be added is preferably in a range from 0.01 to 10 mass % based on the total solid content of the recording layer.

In the image recording layer of the planographic printing plate precursor of the invention, in order to enhance stability in processes which affect conditions of developing, the following can be added: nonionic surfactants as described in JP-A Nos. 62-251740 and 3-208514; amphoteric surfactants as described in JP-A Nos. 59-121044 and 4-13149; siloxane compounds as described in EP No. 950517; and copolymers made from a fluorine-containing monomer as described in JP-A No. 11-288093.

Specific examples of nonionic surfactants include sorbitan tristearate, sorbitan monopalmitate, sorbitan trioleate, monoglyceride stearate, and polyoxyethylene nonyl phenyl ether. Specific examples of amphoteric surfactants include alkyldi(aminoethyl)glycine, alkylpolyaminoethylglycine hydrochloride, 2-alkyl-N-carboxyethyl-N-hydroxyethylimidazolinium betaine and N-tetradecyl-N,N′-betaine type surfactants (trade name: “Amolgen K”, manufactured by Dai-ichi Kogyo Seiyaku Co., Ltd.).

The siloxane compounds are preferably block copolymers made from dimethylsiloxane and polyalkylene oxide. Specific examples thereof include polyalkylene oxide modified silicones (trade names: DBE-224, DBE-621, DBE-712, DBE-732, and DBE-534, manufactured by Chisso Corporation; trade name: Tego Glide 100, manufactured by Tego Co., Ltd.).

The content of the nonionic surfactant and/or the amphoteric surfactant in the photosensitive composition is preferably from 0.05 to 15% by mass, and more preferably from 0.1 to 5% by mass.

To the photosensitive composition of the invention may be added a printing-out agent for obtaining a visible image immediately after the photosensitive composition of the invention has been heated by exposure to light, or a dye or pigment as an image coloring agent.

A typical example of a printing-out agent is a combination of a compound which is heated by exposure to light, thereby emitting an acid (an optically acid-generating agent), and an organic dye which can form salts (salt formable organic dye).

Specific examples thereof include combinations of an o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in each of JP-A Nos. 53-36223, 54-74728, 60-3626, 61-143748, 61-151644 and 63-58440.

The trihalomethyl compound is classified into an oxazol compound or a triazine compound. Both of the compounds provide excellent in stability over the passage of time and produce a vivid printed-out image.

Examples of other photo-acid releasing agent may include various o-naphthoquinonediazide compounds as described in the publication of JP-A No. 55-62444; 2-trihalomethyl-5-aryl-1,3,4-oxadiazole compound as described in the publication of JP-A No. 55-77742; and diazonium salts.

Whenever necessary, a plasticizer may be added to the image recording layer, i.e., the lower-layer coating solution of the invention to give flexibility to a coating film made from the coating solution. Examples of the plasticizer include oligomers and polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl olete, and acrylic acid and methacrylic acid.

The planographic printing plate precursor of the invention may be usually produced by applying a lower layer coating solution and a upper recording layer coating solution which are compounded of the aforementioned components one after another to an appropriate support.

Examples of a solvent appropriate for applying the lower layer and image recording layer include, though not limited to, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone and toluene. These solvents may be used either singly or by mixing them. The concentration of the above components (total solid content including the additives) in the solvent is preferably 1 to 50 mass %.

It is to be noted that the lower layer (lower recording layer) and the upper layer (other recording layer) are preferably formed in such a manner as to separate two layers from each other in principle.

Examples of the method of forming two layers separately include, though not limited to, a method utilizing a difference in solubility in a solvent between the components contained in the lower layer and the components contained in the upper layer and a method in which a solvent is vaporized and removed quickly by drying after the upper layer is applied.

Examples of the method utilizing a difference in solubility in a solvent between the components contained in the lower layer and the components contained in the upper layer include a method using a solvent which does not dissolve the alkali-soluble resin contained in the lower layer when an upper layer coating solution is applied. This makes it possible to separate each layer clearly to form coating films even if two-layer coating is carried out.

For example, components insoluble in solvents such as methyl ethyl ketone and 1-methoxy-2-propanol which dissolve the alkali-soluble resin which is the upper layer component are selected as the lower layer components, the lower layer is applied using a solvent dissolving the lower layer components and dried, then the upper layer components using the alkali-soluble resins primarily are dissolved in methyl ethyl ketone, 1-methoxy-2-propanol or the like and the coating solution is applied and dried whereby the formation of two layers is attained.

When a method is adopted in which a solvent which does not dissolve the alkali-soluble resin contained in the lower layer is used in the case of applying the upper layer coating solution, a solvent which dissolves the alkali-soluble resin contained in the lower layer may be mixed with a solvent which doe not dissolve this alkali-soluble resin. Layer mixing between the upper layer and the lower layer can be arbitrarily controlled by changing the mixing ratio of both solvents.

If the ratio of the solvent that dissolves the alkali-soluble resin contained in the lower layer is increased, a part of the lower layer is dissolved when applying the upper layer and is contained as particle components in the upper layer after the upper layer is dried. The particle component causes projections to be formed on the surface of the upper layer, which betters damage resistance. The dissolution of the lower layer components, on the other hand, tends to deteriorate the film quality of the lower layer and hence resistance to chemicals.

In light of this, it is possible to make various characteristics exhibit themselves (for example, to promote partial compatibility between layers, which will be explained later) by controlling the mixing ratio, taking the characteristics of each solvent into account.

In the case using a mixed solvent as mentioned above as the coating solvent of the upper layer in order to produce the effect of the invention, the amount of the solvent which dissolves the alkali-soluble resin in the lower layer is preferably 80 mass % or less of the amount of the solvent used to apply the upper layer from the viewpoint of resistance to chemicals and more preferably in a range from 10 to 60 mass % taking resistance to damage into account.

Next, as to a method of drying a solvent very quickly after the second layer (upper layer) is applied, high pressure air is sprayed from a slit nozzle located at almost a right angle with respect to the running direction of a web, thermal energy is supplied as conductive heat from the underside of a web through a roll (heating roll) to which a heating medium such as steam is supplied, or a combination of these methods is used, whereby the quick drying of a solvent can be attained.

In the invention, various methods may be used as a method of applying each of the layers such as the image recording layer. Examples of the coating method may include bar coater coating, rotation coating, spray coating, curtain coating, dip coating, air knife coating, blade coating and roll coating.

The coating method used to form the upper layer is preferably carried out in a non-contact system to prevent damages to the lower layer when applying the upper layer. Although bar coater coating, though it is a contact type, may be used as the method generally used in a solvent system coating, it is desirable to carry out coating in forward driving to prevent damages to the lower layer.

The coating amount of the lower recording layer after the layer is dried in the planographic printing plate precursor of the invention is preferably in a range from 0.5 to 1.5 g/m² and more preferably in a range from 0.7 to 1.0 g/m² from the viewpoint of ensuring printing durability and suppressing generation of a residual film during developing.

The amount of the image recording layer (upper layer) after drying (or if there are two or more layers other than the lower layer, the total amount thereof) is preferably in the range of 0.05 to 1.0 g/m², more preferably in the range of 0.07 to 0.7 g/m².

In each of these recording layers, apparent sensitivity is increased as the coating amount is decreased; however, developing latitude and coating film characteristics tend to deteriorate. Particularly in the case where the film thickness of the recording layer is too thick, the recording layer is easily influenced by heat diffusion in the deep part thereof and there is therefore a fear as to a reduction in image forming characteristics in the vicinity of the support.

A surfactant, for example, a fluorine type surfactant as described in the publication of JP-A No. 62-170950 may be added in the coating solutions for the lower layer or other recording layers to better coating characteristics. The amount of the surfactant is preferably 0.01 to 1 mass % and more preferably 0.05 to 0.5 mass % based on the total solid content of the coating solution.

In this manner, a planographic printing plate precursor having a dispersed phase in the lower layer of recording layers in a multi-layered structure can be obtained. Because the lower layer has a dispersed phase, anisotropy of dissolution of the lower layer in an aqueous alkali solution can be achieved.

Next, the method (II) of high-temperature drying of the lower layer, that is, the second means of achieving the anisotropy of dissolution in an aqueous alkali solution, will be described in detail. The formulation of the lower layer in this method is not particularly limited, and can be the same as is generally used for a positive recording layer. However, as described above after formation of the lower layer, consideration must be made of the formation of the upper layer by coating and drying and the alkali soluble resin and coating solvent used should be selected in the context of the upper layer.

The coating conditions and coating amount of the lower layer are the same as described above, however in this embodiment, after the lower layer is applied it is dried at high temperature thereby expressing the heat sensitivity in the lower layer and producing many of the ionic bonds necessary for exhibiting heat sensitivity. Because of this the solubility of the lower layer in the depth direction where the contact area with an aqueous alkali solution is large will not be significantly inhibited, but the solubility in the lateral direction where the contact area is small, that is, the solubility in the side direction of the lower layer will be selectively inhibited.

Coating and drying of a lower layer are conducted usually at 100 to 140° C. for 30 to 60 seconds, however the coating and drying in this embodiment are conducted preferably at a drying temperature of 142 to 200° C. for 30 to 70 seconds. Particularly after the amount of the remaining solvent in the lower layer coating solution applied is decreased to 70% or less the drying is conducted preferably under these drying conditions.

In the method (II), the lower layer and the upper layer may be formed in the same manner as in the above method (I) except that the conditions for drying the lower layer are changed as described above.

[Support]

The support used in the planographic printing plate precursor is a plate having dimensional stability. A plate satisfying required physical properties such as strength and flexibility can be used without any restriction. Examples thereof include paper, plastic (such as polyethylene, polypropylene or polystyrene)-laminated papers, metal plates (such as aluminum, zinc and copper plates), plastic films (such as cellulose biacetate, cellulose triacetate, cellulose propionate, cellulose lactate, cellulose acetate lactate, cellulose nitrate, polyethylene terephthalate, polyethylene, polystyrene, polypropylene, polycarbonate, and polyvinyl acetate films), and papers or plastic films on which, as described above, a metal is laminated or vapor-deposited.

The support is preferably a polyester film or an aluminum plate, and more preferably an aluminum plate, since an aluminum plate is superior in terms of dimensional stability and is also relatively inexpensive.

Preferable examples of the aluminum plate include a pure aluminum plate and alloy plates made of aluminum as a main component with a very small amount of other elements. A plastic film on which aluminum is laminated or vapor-deposited may also be used.

Examples of other elements contained in the aluminum alloys include silicon, iron, manganese, copper, magnesium, chromium, zinc, bismuth, nickel, and titanium. The content by percentage of different elements in the alloy is at most 10% by mass. A particularly preferable aluminum plate in the invention is a pure aluminum plate; however, since from the viewpoint of refining a completely pure aluminum cannot be easily produced, a very small amount of other elements may also be contained in the plate.

The aluminum plate used as the support is not specified in terms of the composition thereof. Thus, aluminum plates which are conventionally known can be appropriately used. The thickness of the aluminum plate used in the invention is from about 0.1 to 0.6 mm, preferably from 0.15 to 0.4 mm, and more preferably from 0.2 to 0.3 mm.

If necessary, prior to the surface-roughening treatment, the aluminum plate may optionally be subjected to degreasing treatment, in order to remove rolling oil or the like on the surface, with a surfactant, an organic solvent, an aqueous alkaline solution or the like.

The surface-roughening treatment of the aluminum surface can be performed by various methods such as a mechanical surface-roughening method, a method of dissolving and roughening the surface electrochemically, and a method of dissolving the surface selectively in a chemical manner.

Mechanical surface-roughening methods which can be used may be known methods, such as a ball polishing method, a brush polishing method, a blast polishing method or a buff polishing method. An electrochemical surface-roughening method may be a method of performing surface-roughening in an electrolyte of hydrochloric acid or nitric acid, by use of an alternating current or a direct current. As disclosed in JP-A No. 54-63902, a combination of the two kinds of methods may be used.

An aluminum plate whose surface is roughened as described above is if necessary subjected to alkali-etching treatment and neutralizing treatment. Thereafter, an anodizing treatment is optionally applied in order to improve the water holding capacity and wear resistance of the surface.

The electrolyte used in the anodizing treatment of the aluminum plate is any one selected from various electrolytes which can form a porous oxide film. Among which in general use are electrolytes of sulfuric acid, phosphoric acid, oxalic acid, chromic acid, or a mixed acid thereof. The concentration of the electrolyte may be appropriately decided depending on the kind of electrolyte selected.

Treatment conditions for anodization cannot be specified as a general rule since conditions vary depending on the electrolyte used; however, the following range of conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of anodic oxide film is less than 1.0 g/m², printing resistance is inadequate or non-image portions of the planographic printing plate tend to become easily damaged and the so-called “blemish stains”, resulting from ink adhering to damaged portions at the time of printing, are easily generated.

After the anodizing treatment, the surface of the aluminum is if necessary subjected to treatment for obtaining hydrophilicity. This securance of hydrophilicity treatment may be an alkali metal silicate (for example, an aqueous sodium silicate solution) method, as disclosed in U.S. Pat. Nos. 2,714,066, 3,181,461, 3,280,734, and 3,902,734. In this method, the support is subjected to an immersing treatment or an electrolyzing treatment with an aqueous sodium silicate solution.

In addition, the following methods may also be used: a method of treating the support with potassium fluorozirconate, as disclosed in JP-B No. 36-22063, or with polyvinyl phosphonic acid, as disclosed in U.S. Pat. Nos. 3,276,868, 4,153,461, and 4,689,272.

The planographic printing plate precursor of the invention comprises at least two layers including the aforementioned lower recording layer and upper recording layer which are laminated on the support. The planographic printing plate precursor may be provided with an undercoat layer between the support and the lower layer according to the need.

As components of the undercoat layer, various organic compounds can be used. Examples thereof include carboxymethylcellulose, dextrin, gum arabic, phosphonic acids having an amino group, such as 2-aminoethylphosphonic acid, organic phosphonic acids which may have a substituent, such as phenyl phosphonic acid, naphthylphosphonic acid, alkylphosphonic acid, glycerophosphonic acid, methylenediphosphonic acid and ethylenediphosphonic acid, organic phosphoric acids which may have a substituent, such as phenylphosphoric acid, naphthylphosphoric acid, alkylphosphoric acid and glycerophosphoric acid, organic phosphinic acids which may have a substituent, such as phenylphosphinic acid, naphthylphosphinic acid, alkylphosphinic acid and glycerophosphinic acid, amino acids such as glycine and β-alanine, and hydrochlorides of amines having a hydroxyl group, such as a hydrochloride of triethanolamine. These organic compounds may be used alone or in the form of a mixture made up of two or more thereof.

This organic undercoat layer may be formed by methods which can be described as follows: a method of applying onto the aluminum plate a solution wherein the above-mentioned organic compound is dissolved in water, or an organic solvent such as methanol, ethanol or methyl ethyl ketone, or a mixed solvent thereof and then drying the resultant aluminum plate, or a method of immersing the aluminum plate into a solution wherein the above-mentioned organic compound is dissolved in water, or an organic solvent such as methanol, ethanol or methyl ethyl ketone, or a mixed solvent thereof so as to adsorb the compound, washing the aluminum plate with water or the like, and then drying the resultant aluminum plate.

In the former method, the solution of the organic compound having a concentration of 0.05 to 10% by mass may be applied in various ways. In the latter method, the concentration of the organic compound in the solution is from 0.01 to 20%, preferably from 0.05 to 5%, the temperature for the immersion is from 20 to 90° C., preferably from 25 to 50° C., and the time taken for immersion is from 0.1 second to 20 minutes, preferably from 2 seconds to 1 minute.

The pH of the solution used in the above-mentioned methods can be adjusted into a range of 1 to 12 with a basic material such as ammonia, triethylamine or potassium hydroxide, or an acidic material such as hydrochloric acid or phosphoric acid. Moreover, a yellow dye may be added to the solution, in order to improve the tone reproducibility of the recording layer.

The amount of organic undercoat layer applied is suitably from 2 to 200 mg/m², preferably from 5 to 100 mg/m². When the above coating amount is less than 2 mg/m², sufficient printing durability is not obtained. Also, when the amount is larger than 200 mg/m², the same result is obtained.

The positive planographic printing plate precursor produced in the above manner is usually subjected to image exposure and developing treatment.

Examples of the light source of the active rays used for image exposure include a mercury lamp, metal halide lamp, xenon lamp, chemical lamp and carbon arc lamp. Examples of the radial rays, electron rays, X-rays, ion beams and far infrared radiation. Also, g-rays, i-rays, Deep-UV light and high-density energy beams (laser beams) may also be used.

Examples of the laser beam include helium.neon laser, argon laser, krypton laser, helium.cadmium laser and KrF excimer laser.

In the invention, the planographic printing plate precursor is preferably exposed to light from, particularly, a light source having an emitting wavelength in the near-infrared region to the infrared region; specifically, the planographic printing plate precursor is preferably exposed imagewiseimage-wise to light from a solid laser or semiconductor laser radiating infrared rays having a wavelength of 760 nm to 1200 nm.

The planographic printing plate precursor of the invention is developed using water or an alkali developing solution after exposure. Although the developing treatment may be carried out immediately after exposure, heating treatment may be carried out between an exposure step and a developing step. When the heat treatment is carried out, the heating is preferably carried out at a temperature range from 60° C. to 150° C. for 5 seconds to 5 minutes. As the heating method, conventionally known various methods may be used. Examples of the heating method include a method in which a recording material is heated with bringing it into contact with a panel heater or ceramic heater and a non-contact method using a lamp or hot air. This heat treatment makes it possible to reduce the energy required for recording when a laser is applied.

As a developing solution and replenishing solution to be used for plate-making of the planographic printing plate of the invention, a conventionally known aqueous alkali solution may be used.

The developing solution which may be applied to the developing treatment of the planographic printing plate precursor of the invention is a developing solution having a pH range from 9.0 to 14.0 and preferably a pH range from 12.0 to 13.5. As the developing solution (hereinafter referred to as a developing solution including a replenishing solution), a conventionally known aqueous alkali solution may be used.

Examples of the alkali agent include inorganic alkali salts such as sodium silicate, potassium silicate, trisodium phosphate, tripotassium phosphate, triammonium phosphate, disodium hydrogenphosphate, dipotassium hydrogenphosphate, diammonium hydrogenphosphate, sodium carbonate, potassium carbonate, ammonium carbonate, sodium hydrogencarbonate, potassium hydrogencarbonate, ammonium hydrogen carbonate, sodium borate, potassium borate, ammonium borate, sodium hydroxide, ammonium hydroxide, potassium hydroxide and lithium hydroxide; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

These alkali agents may be used alone or in combinations of two or more thereof.

Moreover, an aqueous alkali solution comprising a non-reducing sugar and a base may also be used. The non-reducing sugar represents sugars having no reducing ability because they have neither a free aldehyde group nor a ketone group and are classified into trehalose type oligosaccharides in which reducing groups are combined with other, glycosides in which reducing groups of sugars are combined with non-sugars and sugar alcohols in which sugars are reduced by hydrogenation. Any of these non-reducing sugars may be preferably used.

Examples of the trehalose type oligosaccharides include saccharose and trehalose. Examples of the glucosides include alkylglucosides, phenolglucosides, and mustard seed oil glucoside. Examples of the sugar alcohols include D, L-arabite, ribitol, xylitol, D, L-sorbitos, D, L-mannitol, D, L-iditol, D, L-talitol, dulcitol, and allodulcitol. Furthermore, maltitol, obtained by hydrogenating a disaccharide, and a reductant obtained by hydrogenating an oligosaccharide (i.e., reduced starch syrup) are preferable. Of these examples, sugar alcohol and saccharose are more preferable. D-sorbitol, saccharose, and reduced starch syrup are even more preferable since they have buffer effect within an appropriate pH range and are inexpensive.

These nonreducing sugars may be used alone or in combination of two or more thereof. The percentage thereof in the developer is preferably from 0.1 to 30% by mass, more preferably from 1 to 20% by mass from the viewpoints of the buffer effect and the developing power of the solution.

The base combined with the nonreducing sugar(s) may be an alkali agent that has been known so far. Examples thereof include inorganic alkali agents such as sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium hydrogencarbonate, potassium hydrogencarbonate, ammonium hydrogencarbonate, sodium borate, potassium borate and ammonium borate; and

organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

The bases may be used alone or in combination of two or more. Among the bases, sodium hydroxide and potassium hydroxide are preferable. The reason is that pH adjustment can be made in a wide pH range by regulating the amount of the alkali agent to be added to the non-reducing sugar. Also, trisodium phosphate, sodium carbonate, potassium carbonate or the like itself have a buffer action and are hence preferable.

In a case where an automatic developing machine is used to perform development, an aqueous solution having a higher alkali intensity than that of the developer (or, replenisher) can be added to the developer. It is known that this makes it possible to treat a great number of photosensitive plates without recourse to replacing the developer in the developing tank over a long period of time. This replenishing manner is also preferably used in the invention.

If necessary, various surfactants or organic solvents can be incorporated into the developer and the replenisher in order to promote and suppress development capacity, disperse development scum, and enhance the ink-affinity of image portions of the printing plate.

Preferable examples of the surfactant include anionic, cationic, nonionic and amphoteric surfactants. If necessary, the following may be added to the developer and the replenisher: a reducing agent (such as hydroquinone, resorcin, a sodium or potassium salt of an inorganic acid such as sulfurous acid or hydrogen sulfite acid), an organic carboxylic acid, an antifoaming agent, and a water softener.

The printing plate developed with the developer and replenisher described above is subsequently subjected to treatments with washing water, a rinse solution containing a surfactant and other components, and a desensitizing solution containing gum arabic and a starch derivative. For after treatment following use of the photosensitive composition of the invention as a planographic printing plate precursor, various combinations of these treatments may be employed.

In recent years, automatic developing machines for printing plate precursors have been widely used in order to rationalize and standardize plate-making processes in the plate-making and printing industries. These automatic developing machines are generally made up of a developing section and a post-processing section, and include a device for carrying printing plate precursors, various treating solution tanks, and spray devices. These machines are machines for spraying respective treating solutions, which are pumped up, onto an exposed printing plate through spray nozzles, for development, while the printing plate is transported horizontally.

Recently, a method has also attracted attention in which a printing plate precursor is immersed in treating solution tanks filled with treating solutions and conveyed by means of in-liquid guide rolls. Such automatic processing can be performed while replenishers are being replenished into the respective treating solutions in accordance with the amounts to be treated, operating times, and other factors.

A so-called use-and-dispose processing manner can also be used, in which treatments are conducted with treating solutions which in practice have yet been used.

A method of treating the heat-sensitive planographic printing plate precursor of the invention will be explained. In cases where unnecessary image portions (for example, a film edge mark of an original picture film) are present on a planographic printing plate obtained by exposing imagewise to light a planographic printing plate precursor to which the invention is applied, developing the exposed precursor, and subjecting the developed precursor to water-washing and/or rinsing and/or desensitizing treatment(s), unnecessary image portions can be erased.

The erasing is preferably performed by applying an erasing solution to unnecessary image portions, leaving the printing plate as it is for a given time, and washing the plate with water, as described in, for example, JP-B No. 2-13293. This erasing may also be performed by a method of radiating active rays introduced through an optical fiber onto the unnecessary image portions, and then developing the plate, as described in JP-A No. 59-174842.

The planographic printing plate obtained as described above is, if desired, coated with a desensitizing gum, and subsequently the plate can be made available for a printing step. When it is desired to make a planographic printing plate have a higher degree of printing resistance, baking treatment is applied to the planographic printing plate.

In a case where the planographic printing plate is subjected to the baking treatment, it is preferable that before the baking treatment takes place the plate is treated with a surface-adjusting solution as described in JP-B No. 61-2518, or JP-A Nos. 55-28062, 62-31859 or 61-159655.

This method of treatment is, for example, a method of applying the surface-adjusting solution onto the planographic printing plate with a sponge or absorbent cotton infiltrated with the solution, a method of immersing the planographic printing plate in a vat filled with the surface-adjusting solution, or a method of applying the surface-adjusting solution to the planographic printing plate with an automatic coater. In a case where after application the amount of solution applied is made uniform with a squeegee or a squeegee roller, a better result can be obtained.

In general, the amount of surface-adjusting solution applied is suitably from 0.03 to 0.8 g/m² (dry mass). If necessary the planographic printing plate onto which the surface-adjusting solution is applied can be dried, and then the plate is heated to a high temperature by means of a baking processor (for example, a baking processor (BP-1300) sold by Fuji Photo Film Co., Ltd.) or the like. In this case the heating temperature and the heating time, which depend on the kind of components forming the image, are preferably from 180 to 300° C. and from 1 to 20 minutes, respectively.

If necessary, a planographic printing plate subjected to baking treatment can be subjected to treatments which have been conventionally conducted, such as a water-washing treatment and gum coating. However, in a case where a surface-adjusting solution containing a water soluble polymer compound or the like is used, the so-called desensitizing treatment (for example, gum coating) can be omitted. The planographic printing plate obtained as a result of such treatments is applied to an offset printing machine or to some other printing machine, and is used for printing on a great number of sheets.

### EXAMPLES

The invention will be explained by way of examples, which, however, are not intended to bedo not limiting of the scope of the invention.

### Example 1

### Preparation of a Support

<Aluminum Plate>

An aluminum alloy containing 0.06 wt % Si, 0.30 wt % Fe, 0.025 wt % Cu, 0.001 wt % Mn, 0.001 wt % Mg, 0.001 wt % Zn and 0.03 wt % Ti, the balance being Al and inevitable impurities, was used to prepare molten metal. The molten metal was then subjected to molten metal treatment, filtered and formed into an ingot of 500 mm in thickness and 1200 mm in width by a DC casting method. After scalping its surface layer at 10 mm average thickness with a scalping machine, the ingot was soaked at 550° C. for about 5 hours, and when the temperature decreased to 400° C., the ingot was formed into a rolled plate of 2.7 mm in thickness with a hot rolling mill. Then, the plate was subjected to heat treatment at 500° C. with a continuous annealing device and finished with cold rolling to give a plate of 0.24 mm in thickness as an aluminum plate of JIS 1050 material. The minor axis of the average crystalline particle diameter of the resulting aluminum was 50 μm, and the major axis was 300 μm. This aluminum plate was formed into a plate of 1030 mm in width and then subjected to the following surface treatment.

<Surface Treatment>

In the surface treatment, the following treatments (a) to (k) were successively conducted. After each treatment and water washing, remaining liquid was removed with nip rollers.

(a) Mechanical Surface Roughening Treatment

Using an apparatus as described below, the surface of the aluminum plate, while it was supplied with an aqueous suspension of an abrasive (Pumice) having a specific gravity of 1.12 as an abrasive slurry, was subjected to mechanical surface roughening treatment with a rotating roller-shaped nylon brush. The aluminum plate was used in the apparatus with two roller-shaped brushes, an abrasive slurry, and plural supporting rollers. The average particle diameter of the abrasive was 30 μm, and the maximum particle diameter was 100 μm. The nylon brush was made of 6·10 nylon, the length of the brush hair was 45 mm, and the diameter of the brush hair was 0.3 mm. The nylon brush had hairs arranged densely in holes in a stainless steel cylinder of φ300 mm. Three rotating brushes were used. The distance between two supporting rollers (φ200 nm) under the brushes was 300 mm. The brush roller was pressed against the aluminum plate until the load of a driving motor for rotating the brush was increased by 7 kW relative to the load before the brush roller was pressed against the aluminum plate. The direction of rotation of the brush was the same as the direction of movement of the aluminum plate. The number of revolutions of the brush was 200 rpm.

(b) Alkali Etching Treatment

The aluminum plate obtained above was subjected to etching treatment by spraying with an aqueous solution of sodium hydroxide at a concentration of 2.6 wt % and aluminum ions at a concentration of 6.5 wt % at a temperature of 70° C., whereby the aluminum plate was dissolved in an amount of 10 g/m². Thereafter, the aluminum plate was washed by spraying with water.

(c) Desmut Treatment

The aluminum plate was subjected to desmut treatment with an aqueous solution (containing 0.5 wt % aluminum ion) of 1 wt % nitric acid at a temperature of 30° C. and then washed by spraying with water. The aqueous solution of nitric acid used in desmut treatment was waste liquid from the process of electrochemical surface roughening treatment with an alternating current in an aqueous solution of nitric acid.

(d) Electrochemical Surface Roughening Treatment

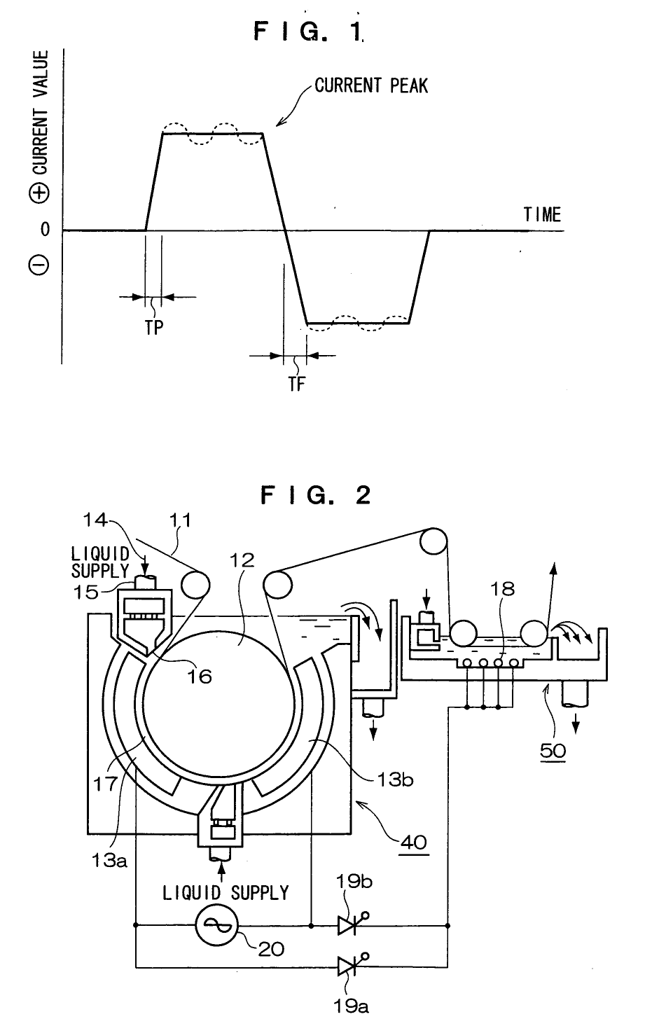

The plate was subjected to continuous electrochemical surface roughening treatment with an alternating voltage of 60 Hz. The electrolyte used was 10.5 g/L aqueous nitric acid solution (containing 5 g/L aluminum ion and 0.007 wt % ammonium ion) at a temperature of 50° C. The electrochemical surface roughening treatment was carried out with a carbon electrode as a counter electrode wherein the alternating current power source waveform had a waveform as shown in FIG. 1, the time required for the electric current to reach from 0 to the peak was 0.8 msec., the duty ratio was 1:1, and a trapezoidal rectangular wave alternating current was used. Ferrite was used as an auxiliary anode. The electrolyte chamber used was as shown in FIG. 2.

The current density was 30 A/dm² in terms of the electric current peak, and the electrical quantity was 220 C/dm² in terms of the total electrical quantity when the aluminum plate was an anode. 5% of the electric current from the power source was fed through the auxiliary anode. Thereafter, the plate was washed by spraying with water.

(e) Alkali Etching Treatment

The aluminum plate was subjected to etching treatment by spraying with an aqueous solution of sodium hydroxide at a concentration of 26 wt % and aluminum ions at a concentration of 6.5 wt % at a temperature of 32° C., whereby the aluminum plate was dissolved in an amount of 0.50 g/m². Smut components, composed in the main of aluminum hydroxide formed by the electrochemical surface roughening treatment using the alternating current in the previous stage, were removed, and the edges of the pits formed were dissolved to smooth the edge. Thereafter, washing by spraying with water was carried out.

(f) Desmut Treatment

The aluminum plate was subjected to desmut treatment with an aqueous solution of 15 wt % nitric acid (containing 4.5 wt % aluminum ions) at a temperature of 30° C. and then washed by spraying with water. The aqueous solution of nitric acid used in the desmut treatment was used as the waste liquid in the process of electrochemical surface roughening treatment with an alternating current in an aqueous solution of nitric acid.

(g) Electrochemical Surface Roughening Treatment

The plate was subjected to continuous electrochemical surface roughening treatment with an alternating voltage of 60 Hz. The electrolyte used herein was 5.0 g/L aqueous hydrochloric acid solution (containing 5 g/L aluminum ions) at a temperature of 35° C. The electrochemical surface roughening treatment was carried out with a carbon electrode as a counter electrode wherein the alternating current power source waveform had a waveform as shown in FIG. 1, the time required for the electric current to reach from 0 to the peak was 0.8 msec., the duty ratio was 1:1, and a trapezoidal rectangular wave alternating current was used. Ferrite was used as an auxiliary anode. The electrolyte chamber used was as shown in FIG. 2.

The current density was 25 A/dm² in terms of the electric current peak, and the electrical quantity was 50 C/dm² in terms of the total electrical quantity when the aluminum plate was the anode. Thereafter, the plate was washed by spraying with water.

(h) Alkali Etching Treatment

The aluminum plate was subjected to etching treatment by spraying with an aqueous solution of sodium hydroxide at a concentration of 26 wt % and aluminum ions at a concentration of 6.5 wt % at a temperature of 32° C., whereby the aluminum plate was dissolved in an amount of 0.10 g/m², and smut components, in the main composed of aluminum hydroxide formed by the electrochemical surface roughening treatment using the alternating current in the previous stage, were removed, and the edges of the pits formed were dissolved to smooth the edges. Thereafter, washing by spraying with water was carried out.

(i) Desmut Treatment

The aluminum plate was subjected to desmut treatment with an aqueous solution (containing 0.5 wt % aluminum ion) of 25 wt % sulfuric acid at a temperature of 60° C. and then washed by spraying with water.

(j) Anodizing Treatment

Anodizing treatment was carried out with an anodizing apparatus having a structure with first and second electrolyte zones of 6 m in length each, first and second current feeding zones of 3 m in length, and first and second current feeding zones of 2.4 m in length. The electrolytes supplied to the first and second electrolytic zones were sulfuric acid. Both the electrolytes were 50 g/L sulfuric acid (containing 0.5 wt % aluminum ions) at a temperature of 20° C. Thereafter, washing by spraying with water was carried out.

In the anodizing apparatus, an electric current from power sources 67a and 67b flowed to a first current feeding electrode 65a arranged in a first current feeding zone 62a, flowed via an electrolyte to the aluminum plate 11 to form an anodizing coating on the surface of the aluminum plate 11 in a first electrolyte zone 63a, passes through electrolyte electrodes 66a and 66b arranged in the first electrolyte zone 63a and was returned to the power sources 67a and 67b.

The electrical quantity fed from the power sources 67a and 67b to the first current feeding zone 62a was equal to the electrical quantity fed from the power sources 67c and 67d to the second current feeding zone 62b, and the current density both in the first electrolyte zone 63a and the second electrolyte zone 63b was about 30 A/dm². The second current feeding zone 62b feeds an electric current via 1.35 g/m² anodizing coating formed in the first electrolyte zone 63a. The final anodized coating was 2.7 g/m².

(k) Alkali Metal Silicate Treatment

The aluminum support obtained by anodizing treatment was subjected to alkali metal silicate treatment (silicate treatment) by dipping it in a treatment bath of 1 wt % aqueous sodium silicate No. 3 at a temperature of 30° C. for 10 seconds. Thereafter, the aluminum support was washed by spraying with water to give a support having a surface rendered hydrophilic with the silicate. After the alkali metal silicate treatment, the resulting aluminum support was coated with an undercoat solution having the following composition and then dried at 80° C. for 15 seconds, to form a coating thereon. The amount of the coating after drying was 15 mg/m².

<Undercoat Solution Composition>

| | | |
|---|---|---|
| The compound below (weight average molecular weight: | 0.3 | g |
| 90,000) | | |
| Methanol | 100 | g |

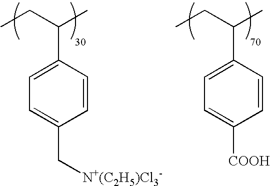

[Formation of Recording Layers (Multi-Layers)]

A lower layer coating solution 1 having the following composition was applied in an amount of 0.85 g/m² by a bar coater onto the resulting web-like substrate and dried at 142° C. for 50 seconds and immediately cooled with cooling air at 17 to 20° C. until the temperature of the substrate was decreased to 35° C.

Thereafter, an upper layer coating solution 1 having the following composition was applied in an amount of 0.22 g/m² via a bar coater onto it and dried at 130° C. for 60 seconds and gradually cooled with air at 20 to 26° C. to prepare the planographic printing plate precursor in Example 1.

<Lower Layer Coating Solution 1>

| | | |
|---|---|---|
| N-(4-Aminosulfonylphenyl) | 1.92 | g |
| methacrylamide/acrylonitrile/methyl meethacrylate | | |
| (36/34/30; weight-average molecular weight 50000; acid | | |
| value, 2.65) | | |
| Novolak resin | 0.192 | g |
| (m-cresol/p-cresol ratio = 60/40, weight-average molecular | | |
| weight 5500) | | |
| Cyanine dye A (the following structure) | 0.134 | g |
| 4,4′-Bishydroxyphenyl sulfone | 0.126 | g |
| Tetrahydrophthalic anhydride | 0.190 | g |
| p-Toluenesulfonic acid | 0.008 | g |
| 3-Methoxy-4-diazodiphenylamine hexafluorophosphate | 0.032 | g |
| Ethyl Violet whose counter ion was replaced by | 0.0781 | g |
| 6-hydroxynaphthalenesulfonic acid | | |
| Polymer 1 (the following structure) | 0.035 | g |
| Methyl ethyl ketone | 25.41 | g |
| 1-Methoxy-2-propanol | 12.97 | g |
| γ-Butyrolactone | 13.18 | g |

Cyanine dye A

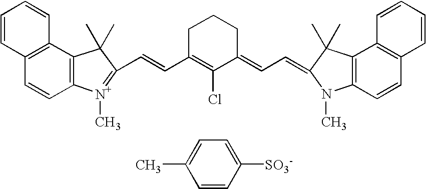

Polymer 1

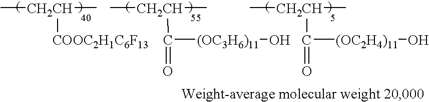

<Upper Layer Coating Solution 1>

| | | |
|---|---|---|
| Phenol, m, p-Cresol novolac | 0.3479 | g |
| (Phenol/m/p ratio = 5/3/2, weight-average molecular weight | | |
| 4500, containing 0.8 wt % unreacted cresol) | | |
| Polymer 3 (the following structure, 30% MEK solution) | 0.1403 | g |
| Cyanine dye A (the above structure) | 0.0192 | g |
| Polymer 1 (the above structure) | 0.015 | g |
| Sulfonium salt (the following structure) | 0.006 | g |
| Methyl eethyl ketone | 6.79 | g |
| 1-Methoxy-2-propanol | 13.07 | g |

Polymer 3

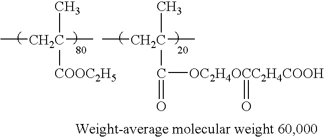

Sulfonium salt

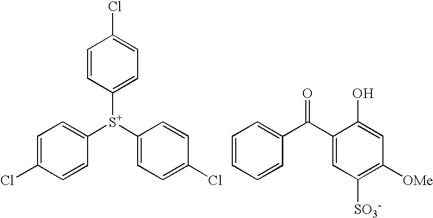

(Confirmation of Dispersed Phase)

The planographic printing plate precursor in Example 1 was cut with a microtome, and the resulting sections of the recording layer were made electroconductive and then photographs thereof were taken with a scanning electron microscope (SEM) and observed, and as a result, the presence of a dispersed phase in the lower recording layer in Example 1 was confirmed. The size of the dispersed phase was in the range of 0.05 to 0.2 μm.

### Examples 2 to 4

The planographic printing plate precursors in Examples 2 to 4 were prepared in the same manner as in Example 1 except that the lower recording layer coating solution 1 used in Example 1, were changed to use the amounts of novolac resin and N-(4-aminosulfonylphenyl) methacrylamide/acrylonitrile/methyl methacrylate resin as shown in Table 1 below.

TABLE 1

| | N-(4-Aminosulfonylphenyl) | |
|---|---|---|
| | methacrylamide/acrylonitrile/ | |
| | methyl methacrylate resin | Novolac resin |
| Example 2 | 1.69 g | 0.42 g |
| Example 3 | 2.00 g | 0.12 g |
| Example 4 | 1.60 g | 0.53 g |

### Example 5

The planographic printing plate precursor in Example 5 was prepared in the same manner as in Example 1 except that the drying conditions in formation of the recording layers in Example 1 were changed to as described below.

That is, the following lower layer coating solution 2 was applied by a bar coater onto the same support as in Example 1 such that the coating amount became 0.85 g/m², and then dried at 170° C. for 35 seconds and immediately cooled with cooling air at 17 to 20° C. until the temperature of the support became 35° C.

Thereafter, the above upper layer coating solution 1 was applied by a bar coater such that the coating amount became 0.22 g/m², and then dried at 140° C. for 60 seconds and then gradually cooled with air at 20 to 26° C., whereby the planographic printing plate precursor in Example 5 was prepared.

<Lower Layer Coating Solution 2>

| | |
|---|---|
| N-(4-Aminosulfonylphenyl) | 2.20 g |
| methacrylamide/acrylonitrile/methyl methacrylate | |
| (36/34/30, weight-average molecular weight | |
| 100,000, acid value 2.65) | |
| m,p-Cresol novolak | 0.11 g |
| (m/p ratio 6/4, weight-average molecular weight 4500, | |
| containing 0.8 wt % unreacted cresol) | |
| Cyanine dye A (the above structure) | 0.109 g |
| 4,4′-Bishydroxyphenyl sulfone | 0.126 g |
| Tetrahydrophthalic anhydride | 0.190 g |
| p-Toluenesulfonic acid | 0.008 g |
| 3-Methoxy-4-diazodiphenylamine hexafluorophosphate | 0.030 g |
| Ethyl Violet whose counterion was replaced by | 0.10 g |
| 6-hydroxynaphthalenesulfonic acid | |
| Fluorine-type surfactant (surface-improving surfactant) | 0.035 g |
| [MEGAFACE F-781F, manufactured by | |
| Dainippon Ink and Chemicals, Inc.] | |
| Methyl ethyl ketone | 24.38 g |
| 1-Methoxy-2-propanol | 13.0 g |
| γ-Butryrolactone | 14.2 g |

### Example 6

The planographic printing plate precursor in Example 6 was prepared in the same manner as in Example 5 except that the drying conditions in formation of the recording layers in Example 5 were changed to as described below.

That is, the following lower layer coating solution 2 was applied by a bar coater onto the same support as in Example 5 such that the coating amount became 0.85 g/m², and then dried at 175° C. for 35 seconds and immediately cooled with a cooling air of 17 to 20° C. until the temperature of the support became 35° C.

Thereafter, an upper layer coating solution 1 having the following composition was applied by a bar coater such that the coating amount became 0.22 g/m², and then dried at 140° C. for 60 seconds and then gradually cooled with air at 20 to 26° C., whereby the planographic printing plate precursor in Example 6 was prepared.

### Comparative Example 1

The planographic printing plate precursor in Comparative Example 1 was prepared in the same manner as in Example 1 except that a lower layer coating solution 3 having the following composition not containing Novolak resin was used in place of the lower layer coating solution 1 of Example 1.

<Lower Layer Coating Solution 3>

| | |
|---|---|
| N-(4-Aminosulfonylphenyl) | 2.13 g |
| methacrylamide/acrylonitrile/methyl methacrylate | |
| (36/34/30, weight-average molecular weight | |
| 50,000, acid value 2.65) | |
| Cyanine dye A (the structure below) | 0.134 g |
| 4,4′-Bishydroxyphenyl sulfone | 0.126 g |
| Tetrahydrophthalic anhydride | 0.190 g |
| p-Toluenesulfonic acid | 0.008 g |
| 3-Methoxy-4-diazodiphenylamine hexafluorophosphate | 0.032 g |
| Ethyl Violet whose counterion was replaced by | 0.0781 g |
| 6-hydroxynaphthalenesulfonic acid | |
| Polymer 1 (the above structure) | 0.035 g |
| Methyl ethyl ketone | 25.41 g |
| 1-Methoxy-2-propanol | 12.97 g |
| γ-Butryrolactone | 13.18 g |

### Comparative Example 2

The planographic printing plate precursor in Comparative Example 2 was prepared in the same manner as in Example 1 except that the conditions for formation of the recording layers in Example 1 were changed to as shown below.

The above lower layer coating solution 1 was applied by a bar coater onto a support coated with the same lower layer coating solution as in Example 1 such that the coating amount became 0.85 g/m², and then dried at 110° C. for 120 seconds and immediately cooled with cooling air at 17 to 20° C. until the temperature of the support became 35° C.

Thereafter, the upper layer coating solution 1 having the above composition was applied by a bar coater such that the coating amount became 0.22 g/m², and then dried at 140° C. for 60 seconds and then gradually cooled with air at 20 to 26° C., whereby the planographic printing plate precursor in Comparative Example 2 was prepared.

### Example 7

The planographic printing plate precursor in Example 1 was prepared in the same manner as in Example 1 except that an upper layer coating solution 3 having the following composition was used in place of the upper layer coating solution 1 of Example 1.

<Upper Layer Coating Solution 3>

| | | |
|---|---|---|
| Novolak resin 2 | 0.3479 | g |
| (phenol/m/p ratio '2 5/4/1, weight-average molecular | | |
| weight 5300, containing 1.5 wt % unreacted cresol) | | |
| Polymer 3 (the above structure: 30% MEK solution) | 0.1403 | g |
| Cyanine dye A (the above structure) | 0.0192 | g |
| Polymer 1 (the above structure) | 0.015 | g |
| Polymer 2 (the following sstructure) | 0.00328 | g |
| Sulfonium salt (the following sstructure) | 0.08 | g |
| Surfactant | 0.008 | g |
| (Polyoxyethylene sorbitol fatty ester, HLB 8.5, trade name: | | |
| GO-4 manufactured by Nikko Chemicals Co., Ltd.) | | |
| Methyl ethyl ketone | 6.79 | g |
| 1-Methoxy-2-propanol | 13.07 | g |

Polymer 2

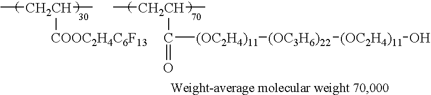

Sulfonium salt

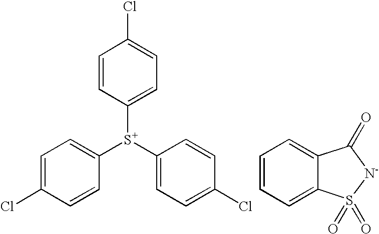

### Example 8

The planographic printing plate precursor in Example 8 was prepared in the same manner as in Example 7 except that a support prepared below was used in place of the support in Example 7.

[Preparation of the Support]

After the surface of an aluminum plate (material: JIS A1050) of 0.30 mm in thickness was subjected to etching treatment with caustic soda at a concentration of 30 g/l and aluminum ions at a concentration of 10 g/l at a solution temperature of 60° C. for 10 seconds, it was washed with running water, neutralized with 10 g/l nitric acid and washed with water. The support was subjected to electrochemical surface roughening treatment with a sine-wave electric current of 500 C/dm² in an alternating waveform at an applied voltage (Va) of 20 V in an aqueous solution containing hydrogen chloride at a concentration of 15 g/l and aluminum ions at a concentration of 10 μl at a solution temperature of 30° C. After washing with water, the support was subjected to etching treatment with caustic soda at a concentration of 30 μl and aluminum ion at a concentration of 10 g/l at a solution temperature of 40° C. for 10 seconds and then washed with running water. Then, the support was subjected to desmut treatment in an aqueous sulfuric acid solution containing sulfuric acid at a concentration of 15% by weight at a solution temperature of 30° C. and then washed with water. The support was then subjected to anodizing treatment at a direct current of 6 A/dm² in 10 wt % aqueous sulfuric acid solution at a solution temperature of 20° C. to form a 2.5 g/m² anodized coating thereon, then washed with water and dried. Thereafter, the support was treated with 2.5 wt % aqueous sodium silicate solution at 30° C. for 10 seconds to prepare a substrate. The central line surface roughness (Ra) of the substrate, as determined by a needle of 2 μm in thickness, was 0.3 μm. The thus obtained aluminum substrate after silicate treatment was coated with an undercoat solution having the following composition and dried at 80° C. for 15 seconds to form a coating thereon. The amount of the coating after drying was 17 mg/m².

### Example 9

(Formation of Recording Layers (Multi-Layers))

A lower layer coating solution 4 having the following composition was applied by a bar coater onto the same support as in Example 1 such that the coating amount became 0.85 g/m², and then dried at 180° C. for 35 seconds and immediately cooled with cooling air at 17 to 20° C. until the temperature of the support became 35° C.

Thereafter, the upper layer coating solution 1 having the composition above was applied by a bar coater such that the coating amount became 0.22 g/m², and then dried at 140° C. for 60 seconds and then gradually cooled with air at 20 to 26° C., whereby the planographic printing plate precursor in Example 9 was prepared.

<Lower Layer Coating Solution 4>

| | |
|---|---|
| N-(4-Aminosulfonylphenyl) | 2.30 g |
| methacrylamide/acrylonitrile/methyl methacrylate | |
| (36/34/30, weight-average molecular weight | |
| 50,000, acid value 2.65) | |
| Cyanine dye A (the above structure) | 0.115 g |
| 4,4′-Bishydroxyphenyl sulfone | 0.126 g |
| Tetrahydrophthalic anhydride | 0.190 g |
| p-Toluenesulfonic acid | 0.008 g |
| 3-Methoxy-4-diazodiphenylamine hexafluorophosphate | 0.030 g |
| Ethyl Violet whose counterion was replaced by | 0.10 g |
| 6-hydroxynaphthalenesulfonic acid | |
| Fluorine-type surfactant (surface-improving surfactant) | 0.035 g |
| [MEGAFACE F-781F, manufactured by | |
| Dainippon Ink and Chemicals, Inc.] | |
| Methyl ethyl ketone | 24.38 g |
| 1-Methoxy-2-propanol | 13.0 g |
| γ-Butryrolactone | 14.2 g |

[Evaluation of the Planographic Printing Plate Precursor]
[Ratio of the Dissolution Speed in the Lateral Direction to the Dissolution Speed in the Depth Direction of the Lower Layer to an Aqueous Alkali Solution (Dissolution Anisotropy)]
(Dissolution Speed in the Lateral Direction)

Each of the resulting planographic printing plate precursors of the invention and the planographic printing plate precursors in the Comparative Examples was used to draw a test pattern (50% 175 lpi) imagewise thereon with a beam intensity of 9 W at a drum revolution of 150 rpm with a Trendsetter manufactured by Creo. Each of the planographic printing plate precursors in Examples 1 to 8 and Comparative Examples 1 and 2, exposed to light under the conditions described above, was placed in a vat charged with a developing solution DT-2 (diluted DT-2:water=1:8) manufactured by Fuji Photo Film Co., Ltd., and then developed for a developing time of 0 to 12 seconds at a temperature of 30° C. The edge of the resulting image (light-unexposed region) was observed under an electron microscope (Hitachi S-800 manufactured by Hitachi, Ltd.). Anisotropy was determined according to the calculation described later.

(Dissolution Speed in the Depth Direction)

Each of the planographic printing plate precursors in Examples 1 to 9 and Comparative Examples 1 and 2, were coated with the recording layers up to the lower layer, and then placed in a vat charged with a developing solution DT-2 (DT-2:water=1:8) manufactured by Fuji Photo Film Co., Ltd., and developed for a developing time of 0 to 30 seconds at a temperature of 30° C.

Thereafter, the color density of coating remaining on the plate was measured with a reflection densitometer (manufactured by Gretag), and the thickness of the coating was calculated from the measured density, and from the time required for dissolution, the speed in the depth direction was calculated. The results are shown in the item “Ratio of dissolution speed” in Table 2 below.
Dissolution speed in the lateral direction={[(theoretical side length of 50% 175 lpi)−(side length after 12 seconds)]/2}/12
Speed in the depth direction=thickness of the lower layer/time required for dissolution
Dissolution anisotropy(ratio of dissolution speed)=(speed in the lateral direction/speed in the depth direction)
[Evaluation of Scratch Resistance]

Each of the planographic printing plates in Examples 1 to 9 and Comparative Examples 1 and 2 was abraded 15 times with an abrasive felt CS5 under 250 g load by using a rotary abrasion tester (manufactured by TOYOSEIKI).

Thereafter, the planographic printing plate was developed at a development temperature of 30° C. for a development time of 12 seconds with a PS Processor 940HII (Fuji Photo Film Co., Ltd.) charged with dilutions at different degrees of dilution prepared from a developing solution DT-2 (diluted DT-2:water=1:8) produced by Fuji Photo Film Co., Ltd. The electrical conductivity during this development was 45 mS/cm. Evaluation of scratch resistance was carried out against the following criteria. A or B levels are, in practice, unproblematic. The results were shown in Table 2 below.

<Evaluation Criteria for Scratch Resistance>

A: Optical density of the abraded portion of the photosensitive coating was not changed at all.

B: Optical density of the abraded portion of the photosensitive coating was slightly observed.

C: Optical density of the abraded portion of the photosensitive coating was decreased to ⅔ or less relative to that of non-abraded portions.

[Sharpness of Image]

Each of the resulting planographic printing plate precursors 1 to 9 of the invention and the planographic printing plate precursors in the Comparative Examples 1 and 2 was used to draw a test pattern (Staccato 10) imagewise thereon with a beam intensity of 9 W at a drum revolution of 150 rpm with a Trendsetter manufactured by Creo. Each of the planographic printing plate precursors 1 to 8 exposed to light under the conditions described above was developed with PS Processor 940HII (manufactured by Fuji Photo Film Co., Ltd.) charged with a developing solution DT-2 (diluted DT-2:water=1:8) produced by Fuji Photo Film Co., Ltd. and developed for a developing time of 12 seconds at a temperature of 30° C. The edge of the resulting image was observed under an electron microscope (Hitachi S-800 manufactured by Hitachi, Ltd.). The sharpness of the image was evaluated against the following criteria. The results were shown in Table 2 below.

<Evaluation Criteria for the Sharpness of the Image>

A: The side of the image was straight.

B: A part of the side of the image was slightly lacking.

C: ½ of the side of the image was lacking.

TABLE 2

| | | Size of | Ratio of | Image | |
|---|---|---|---|---|---|
| | Dispersed | dispersed | dissolution | sharp- | Scratch |
| | phase | phase (μm) | speed | ness | resistance |
| Example 1 | Present | 0.05-0.20 | 0.7 | A | A |
| Example 2 | Present | 0.06-0.45 | 0.65 | A | A |
| Example 3 | Present | 0.05-0.15 | 0.61 | A | A |
| Example 4 | Present | 0.07-0.60 | 0.66 | A | A |
| Example 5 | Present | 0.02-0.10 | 0.71 | A | A |
| Example 6 | Present | 0.015-0.09 | 0.68 | A | A |
| Example 7 | Present | 0.05-0.20 | 0.72 | A | A |
| Example 8 | Present | 0.013-0.10 | 0.60 | A | A |
| Example 9 | Absent | — | 0.9 | A | A |
| Comparative | Absent | — | 1.2 | C | A |
| Example 1 | | | | | |
| Comparative | Present | 0.15-0.25 | 1.0 | B | C |
| Example 2 | | | | | |

As is evident from Table 2, it is found that any of the planographic printing plate precursors in Examples 1 to 9, each having a lower layer wherein at least the condition that the ratio of the dissolution speed in the lateral direction to the dissolution speed in the depth direction (dissolution anisotropy) is less than 1 is satisfied, when compared with the planographic printing plate precursors in Comparative Examples 1 and 2, each having a lower layer wherein the ratio of dissolution speed is 1 or more, can give sharper images while scratch resistance is maintained at a level which does not cause any practical problems.

What is claimed is:

1. A planographic printing plate precursor comprising:
a support and
a positive recording layer arranged on the support. the positive recording layer containing resin and an infrared absorber and being constituted of two or more sub-layers,
wherein the solubility of the positive recording layer to an aqueous alkali solution is increased by exposure to infrared laser light, and for the positive recording sub-layer of the two or more positive recording sub-layers that is nearest to the support, the ratio of the dissolution speed to an aqueous alkali solution in the lateral direction to the dissolution speed in the depth direction is less than 1.

2. The planographic printing plate precursor of claim 1, wherein the ratio of the dissolution speeds is 0.9 or less.

3. The planographic printing plate precursor of claim 2, wherein the ratio of the dissolution speeds is 0.85 or less.

4. The planographic printing plate precursor of claim 1, wherein the positive recording sub-layer nearest to the support has a dispersed phase constituting a sea island structure.

5. The planographic printing plate precursor of claim 4, wherein a matrix phase serving as a dispersing medium of the dispersed phase, comprises a polymer compound insoluble in water and soluble in an aqueous alkali solution, and the dispersed phase contains a compound generating an acid or radical by irradiation with an infrared laser.

6. The planographic printing plate precursor of claim 4, wherein a matrix phase serving as a dispersing medium of the dispersed phase, comprises a polymer compound insoluble in water and soluble in an aqueous alkali solution, and the dispersed phase contains a compound having alkali solubility changed by irradiation with an infrared laser.

7. The planographic printing plate precursor of claim 4, wherein the maximum major axis of the dispersed phase is 0.1 to 0.8 μm, and the average major axis thereof is 0.05 to 0.6 μm.

8. The planographic printing plate precursor of claim 7, wherein the maximum major axis of the dispersed phase is 0.1 to 0.7 μm, and the average major axis thereof is 0.05 to 0.5 μm.

9. A planographic printing plate precursor comprising:
a support and
a positive recording layer arranged on the support, the positive recording layer containing resin and infrared absorber, including at least a lower layer adjacent to the support and an upper layer on the lower layer and having solubility to an aqueous alkali solution that is increased by exposure to infrared laser light, wherein:
the lower layer contains a dispersed phase constituting a sea island structure and a matrix phase serving as a dispersing medium of the dispersed phase;
after exposure to infrared laser light, the solubility in an aqueous alkali solution of the dispersed phase is higher than that of the matrix phase; and
the ratio of the dissolution speed of the lower layer in an aqueous alkali solution in the lateral direction to the dissolution speed in the depth direction is less than 1.

10. The planographic printing plate precursor of claim 9, wherein the ratio of the dissolution speeds is 0.9 or less.

11. The planographic printing plate precursor of claim 10, wherein the ratio of the dissolution speeds is 0.85 or less.

12. The planographic printing plate precursor of claim 9, wherein the matrix phase comprises a polymer compound insoluble in water and soluble in an aqueous alkali solution, and the dispersed phase contains a compound generating an acid or radical by irradiation with an infrared laser.

13. The planographic printing plate precursor of claim 9, wherein the matrix phase comprises a polymer compound insoluble in water and soluble in an aqueous alkali solution, and the dispersed phase contains a compound having alkali solubility changed by irradiation with an infrared laser.

14. The planographic printing plate precursor of claim 9, wherein the maximum major axis of the dispersed phase is 0.1 to 0.8 μm, and the average major axis thereof is 0.05 to 0.6 μm.

15. The planographic printing plate precursor of claim 14, wherein the maximum major axis of the dispersed phase is 0.1 to 0.7 μm, and the average major axis thereof is 0.05 to 0.5 μm.

16. A method of producing a planographic printing plate precursor including a support and a positive recording layer arranged on the support, the positive recording layer containing resin and infrared absorber and being constituted of two or more positive recording sub-layers, the solubility of the positive recording layer to an aqueous alkali solution being increased by exposure to infrared laser light, and for the positive recording sub-layer of the two or more positive recording sub-layers that is nearest to the support, the ratio of the dissolution speed to an aqueous alkali solution in the lateral direction to the dissolution speed in the depth direction being less than 1, comprising:
(a) forming the positive recording sub-layer of the two or more positive recording sub-layers that is nearest to the support, and
(b) forming another positive recording sub-layer adjacent to the positive recording sub-layer nearest to the support,
wherein process (a) includes forming a dispersed phase in the positive recording sub-layer nearest to the support, and/or drying at high temperature the positive recording sub-layer nearest to the support thus formed.

17. The method of producing a planographic printing plate precursor of claim 16, wherein the process (a) of forming a dispersed phase in the positive recording sub-layer nearest to the support includes forming the dispersed phase by using a combination of two resins that are not mutually soluble.

18. The method of producing a planographic printing plate precursor of claim 16, wherein the process (a) of forming a dispersed phase in the positive recording layer nearest to the support includes forming the dispersed phase by dispersing a granular polymer selected from microcapsules and/or latex in a matrix resin.

19. The method of producing a planographic printing plate precursor of claim 16, which further comprises making the solubility in an aqueous alkali solution after exposure to an infrared laser of the dispersed phase to be higher than that of a matrix phase serving as a dispersing medium of the dispersed phase.

20. A method of producing a planographic printing plate precursor including a support and a positive recording layer arranged on the support, the positive recording layer containing resin and infrared absorber, including at least a lower layer adjacent to the support and an upper layer on the lower layer and having solubility to an aqueous alkali solution that is increased by exposure to infrared laser light, the lower layer containing a dispersed phase constituting a sea island structure and a matrix phase serving as a dispersing medium of the dispersed phase, after exposure to infrared laser light the solubility in an aqueous alkali solution of the dispersed phase being higher than that of the matrix phase, and the ratio of the dissolution speed of the lower layer in an aqueous alkali solution in the lateral direction to the dissolution speed in the depth direction being less than 1, comprising:
forming a dispersed phase in the lower layer by bar coating; and
forming another positive recording layer adjacent to the lower layer after drying the lower layer at high temperature.
